(19) United States
(12) Patent Application Publication
(10) Pub. No.: US 2024/0239958 A1
(43) Pub. Date: Jul. 18, 2024

(54) DEGRADABLE COPOLYMERS OF ENOL ETHERS WITH OLEFINIC MONOMERS

(71) Applicant: The Board of Trustees of the Leland Stanford Junior University, Stanford, CA (US)

(72) Inventors: J. D. FEIST, Stanford, CA (US); Yan XIA, Stanford, CA (US)

(73) Assignee: The Board of Trustees of the Leland Stanford Junior University, Stanford, CA (US)

(21) Appl. No.: 18/553,177

(22) PCT Filed: Mar. 31, 2022
(86) PCT No.: PCT/US2022/022900

§ 371 Date: Sep. 28, 2023

Related U.S. Application Data
(60) Provisional application No. 63/169,588, filed on Apr. 1, 2021.

(51) Int. Cl. C08G 65/26; C09D 7/40; C09D 171/00

(52) U.S. Cl. CPC C08G 65/266; C08G 65/2615; C08G 65/2633; C09D 7/70; C09D 171/00

(57) ABSTRACT

A polymer is the reaction product of a substituted or unsubstituted 2,3-dihydrofuran, a substituted or unsubstituted 2,3-dihydropyran, or a mixture of any two or more thereof with a substituted or unsubstituted cycloalkenyl monomer, or a mixture of any two or more thereof, in the presence of a ring-opening metathesis catalyst. In some embodiments, the substituted or unsubstituted cycloalkenyl monomer is a substituted or unsubstituted norbornene monomer.

### CROSS REFERENCE TO RELATED APPLICATIONS

This application claims the benefit of priority to U.S. Provisional Patent Application No. 63/169,588 filed Apr. 1, 2021, which is hereby incorporated by reference, in its entirety for any and all purposes.

### GOVERNMENT RIGHTS

This invention was made with Government support under contract 1553780 awarded by the National Science Foundation. The Government has certain rights in the invention.

### FIELD

The present technology is generally related to ring-opening metathesis polymers and the processes of making them. More specifically it is related to norbornene-based polymers modified with ring-opening polymerized dihydropyrans and dihydrofurans.

### SUMMARY

In one aspect, a polymer is the reaction product of a substituted or unsubstituted 2,3-dihydrofuran, a substituted or unsubstituted 2,3-dihydropyran(3,4-dihydro-2H-pyran), or a mixture of any two or more thereof with a substituted or cycloalkenyl monomer, or a mixture of any two or more thereof in the presence of a ring-opening metathesis catalyst.

In another aspect, a polymer is the reaction product of a substituted or unsubstituted heterocyclic cycloalkenyl compound, wherein the heterocycle includes O, N, or S in the ring, and having at least one alkenyl moiety, or a mixture of any two or more thereof with a substituted or cycloalkenyl monomer, or a mixture of any two or more thereof in the presence of a ring-opening metathesis catalyst.

In another aspect, a process of preparing a polymer is provided, the process including contacting a substituted or unsubstituted 2,3-dihydrofuran, a substituted or unsubstituted 2,3-dihydropyran, or a mixture of any two or more thereof with a substituted or unsubstituted cycloalkenyl monomer, or a mixture of any two or more thereof in the presence of a ring-opening metathesis catalyst.

### BRIEF DESCRIPTION OF THE DRAWINGS

FIGS. 1A, 1B, 1C, and 1D are GPC traces for copolymers of DHF and their respective acid-catalyzed hydrolytic degradation products, according to the examples.

FIG. 2 is the olefin region of ¹³C NMR spectra of poly(DHF)(top), poly(1) (bottom), and P1 (middle), where representative monomer triads of P1 are depicted, according to the examples.

FIG. 3, illustrates representative stress-strain curves of uncrosslinked and crosslinked NBE-DHF copolymers, according to the examples.

FIG. 4 is a differential scanning calorimetry (DSC) measurement of P1 under N₂ atmosphere with a heating rate of 10° C./min, according to the examples.

FIG. 5 is a differential scanning calorimetry (DSC) measurement of P5 under N₂ atmosphere with a heating rate of 10° C./min, according to the examples.

FIG. 6 is a differential scanning calorimetry (DSC) measurement of P6 under N₂ atmosphere with a heating rate of 10° C./min, according to the examples.

FIGS. 7A and 7B illustrates GPC traces of (FIG. 7A) Pt and (FIG. 7B) P2 with their respective acid-catalyzed degradation products, according to the examples.

FIG. 8 illustrates GPC traces of 1/DHF copolymer at a total target DP=600 synthesized with and without added 3-bromopyridine, according to the examples.

FIG. 9 illustrates GPC traces showing the degradation of P7 under aqueous conditions with 5% v/v acetic acid, according to the examples.

FIG. 10 is a GPC trace of P8 demonstrating the compatibility of acrylate groups with DHF-NBE co-ROMP, according to the examples.

FIG. 11 is a GPC trace of PS2 (acrylate terpolymer), according to the examples.

FIG. 12 illustrates a kinetic study of ROMP of NBE 1 and DHF using G3 at [I]₀=[DHF]₀=0.15 M and room temperature, where DHF was fixed at 100 equiv (to G3) and 1 was varied at 50, 100, or 200 equiv (to G3), where the dotted lines are the best-fit linear trendlines, according to the examples.

FIG. 13 is a Fineman-Ross plot for the copolymerization of 1 with DHF with linear fit line, linear fit equation, and fit parameter R², according to the examples.

FIG. 14 illustrates GPC traces of PS4 before and after functionalization with benzylamine, according to the examples.

FIG. 15 is a GPC trace of degraded crosslinked polymer P10, according to the examples.

FIG. 16 illustrates stress-strain curves of P10 immediately following synthesis and after storing for 14 days under ambient conditions, according to the examples.

FIG. 17 illustrates GPC traces from copolymerization reactions using 20 and 50 equivalents of 2,3-dihydrofuran with 1,5-cycloctadiene, wherein the polymer product was prepared and degraded using dilute HCl in tetrahydrofuran.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

As used herein, “heteroaryl” refers to a cyclic aromatic compound that contains one or more heteroatoms selected from the group consisting of nitrogen, oxygen, and sulfur in the ring. The “heteroaryl” group can be made up of two or more fused rings (rings that share two adjacent atoms). When the heteroaryl is a fused ring system, then the ring that is connected to the rest of the molecule has a fully delocalized pi-electron system. The other ring(s) in the fused ring system may or may not have a fully delocalized pi-electron system. Examples of heteroaryl rings include, without limitation, furan, thiophene, phthalazinone, pyrrole, oxazole, thiazole, imidazole, pyrazole, isoxazole, isothiazole, triazole, thiadiazole, pyridine, pyridazine, pyrimidine, pyrazine and triazine.

Wherever “hetero” is used it is intended to mean a group as specified, such as an alkyl or an aryl group, where at least one carbon atom has been replaced with a heteroatom selected from nitrogen, oxygen and sulfur.

As used herein, “heterocycloalkyl.” refers to a ring having in the ring system one or more heteroatoms independently selected from nitrogen, oxygen and sulfur. The ring may also contain one or more double bonds provided that they do not form a fully delocalized pi-electron system in the rings. The ring defined herein can be a stable 3- to 18-membered ring that consists of carbon atoms and from one to five heteroatoms selected from the group consisting of nitrogen, oxygen, and sulfur. Heterocycloalkyl groups of the presently disclosed compounds may be unsubstituted or substituted. When substituted, the substituent(s) may be one or more groups independently selected from the group consisting of halogen, hydroxy, protected hydroxy, cyano, nitro, alkyl, alkoxy, acyl, acyloxy, carboxy, protected carboxy, amino, protected amino, carboxamide, protected carboxamide, alkylsulfonamido and trifluoromethane-sulfonamido. The “heterocycloalkyl” group can be made up of two or more fused rings (rings that share two adjacent carbon atoms). When the heterocycloalkyl is a fused ring system, then the ring that is connected to the rest of the molecule is a heterocycloalkyl as defined above. The other ring(s) in the fused ring system may be a cycloalkyl, a cycloalkenyl, an aryl, a heteroaryl, or a heterocycloalkyl.

Ring-opening metathesis polymerization (ROMP) has emerged as a versatile strategy to synthesize a wide variety of functional polymers from endocyclic olefinic monomers. The term “ring-opening metathesis polymerization (ROMP)” refers to a type of olefin metathesis chain-growth polymerization that is driven by the relief of ring strain in cyclic olefins (e.g. norbornene or cyclopentene). Because ROMP incorporates the entire monomer ring into the polymer backbone it constitutes, incorporation of degradable linkages into the monomer is a theoretically straightforward procedure to synthesize degradable materials. To date however, the most commonly synthesized ROMP polymers are derived from norbornenes (NBEs) or cyclic olefins and contain only nondegradable hydrocarbon backbones. While degradable ROMP monomers have been successfully utilized, their multistep syntheses and relatively uncontrolled polymerizations make them non-ideal for widespread applications.

Herein is demonstrated that addition of commercially available 2,3-dihydrofuran (DHF) and/or 2,3-dihydropyran (DHP) to Ring-Opening Metathesis Polymerization (“ROMP”) of various substituted and unsubstituted norbornenes (NBEs) is a facile and versatile method for the synthesis of functional and fully degradable polymers. This strategy maintains the favorable characteristics of living ROMP, including molecular weight control, high tolerance of functionalities, and tunable polymer properties.

In some embodiments, the synthesis is illustrated by Scheme 1.

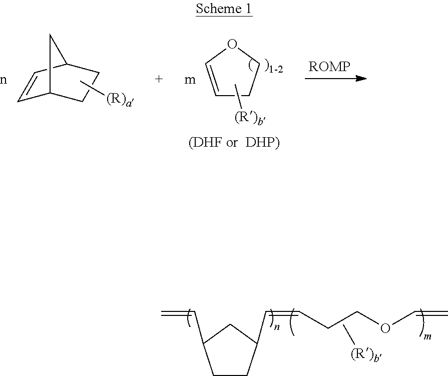

In Scheme 1, R and R′, if present, are each individually substituents; a′ is 0 or an integer of 1 to 6; b′ is 0 or an integer of 1 or 2; n is an integer of 2-1,000,000; and m is an integer of 2-1,000,000. In some embodiments, n is an integer of 2-500,000. In some embodiments, n is an integer of 2-100,000. In some embodiments, n is an integer of 2-3,000. In some embodiments, m is an integer of 2-500,000. In some embodiments, m is an integer of 2-100,000. In some embodiments, m is an integer of 2-3,000.

In some embodiments, R is selected from the following optionally substituted groups: an alkyl, a haloalkyl, ether, ketone, ester, amide, cycloalkyl, cycloalkenyl, heterocycle, and aryl. It will be understood that a cyclic group can be bonded to two atoms of the NBE, or may be bonded to one atom of the NBE. In some embodiments, R′ is H or selected from the following optionally substituted groups: an alkyl, ether, ketone, ester, amide, cycloalkyl, heterocycle, or aryl. In some embodiments, R′ is H or selected from the following optionally substituted groups: an alkyl, ether, ketone, ester, amide, cycloalkyl, or heterocycle. In some embodiments, two adjacent R groups form a 3-6 membered ring. For example:

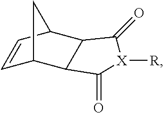

where X is NR″ or CHR″, or DCPD. In some embodiments, R includes a polyethylene glycol moiety with 2-25,000 repeating units. In some embodiments, R includes one or more cross-linkable group, such as a (meth)acrylate or (meth)acrylamide moiety. Examples of NBEs with various R moieties include the following:

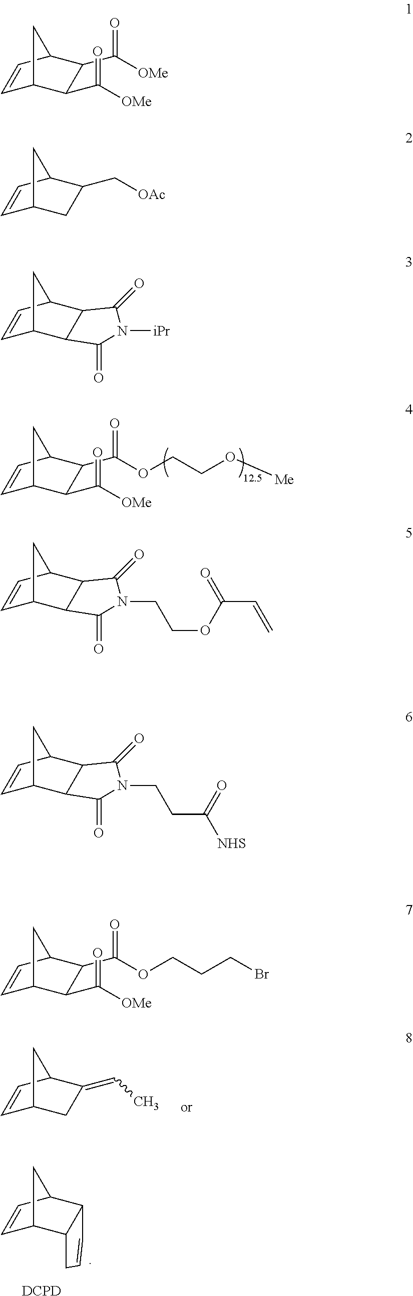

Examples of NBEs that may include heteroatoms include the following:

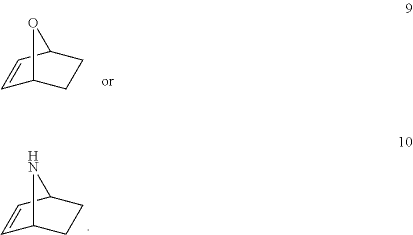 [SMILES: C1=CC2CCC1O2 ; C1=CC2CCC1N2]

Various applications for the polymers formed are possible. For example, in a first application, a modified linear dicyclopentadiene is formed. Poly(dicyclopentadiene) (pDCPD) is a commercial plastic material that is prepared by ROMP and is currently experiencing an increase in market growth rate. It is used for the production of agricultural equipment, automotive body panels, piping, engineering material reinforcement, downhole tools, subsea insulation, circuit boards, pressure vessels, and parts for the energy generating industry, among others. Typically-prepared pDCPD is limited by its high crosslink density which limits its processability, recyclability, and mechanical properties. Despite the extremely high impact toughness of pDCPD, studies have shown that lowering the number of crosslinks in pDCPD further enhances its material properties. It has been claimed that one of the main challenges surrounding the pDCPD market is gaining control over crosslinking.

It was found that neat copolymerization of 2,3-dihydrofuran (DHF) with pDCPD at moderate temperature (˜40° C.) prevents the formation of crosslinks, and providing a strategy to easily generate linear pDCPD. Conversely, preparation of pDCPD at elevated temperature (˜50-200° C.), may result in insoluble, crosslinked material. By varying the amount of DHF or DHP added to the reaction's monomer feed, the material properties of the resulting linear pDCPD can be tuned. For example, linear pDCPD generated from a 1:1 molar ratio of DHF or DHP:DCPD is a rubber elastomer. However, pDCPD from a 1:9 DHF or DHP:DCPD molar ratio is a stiff, strong material.

This linear polymer can be readily dissolved in common organic solvents (e.g., tetrahydrofuran, dichloromethane, chloroform, etc.), enabling solvent-based processing techniques. Due to the incorporation of degradable DHF or DHP units into the linear pDCPD, these materials can also be degraded by exposure to acid and water. The degree of degradation is dependent on the DHF or DHP:DCPD monomer ratio used during polymerization, with higher DHF or DHP loading resulting in smaller degradation fragments.

The linear polymer can also be thermally crosslinked at elevated temperatures. This process generates a thermoset material that, like traditionally cured pDCPD, is completely insoluble. However, this crosslinked material can be degraded into soluble fragments upon treatment with HCl and water in THF. It has been previously shown that degraded pDCPD fragments can be effectively recycled by mixing with virgin DCPD prior to curing.

DHF or DHP/DCPD copolymerization is compatible with frontal ROMP (FROMP). FROMP is an emerging technology that uses minimal energy input to cure large volumes of monomer resin. Typical FROMP utilizes catalyst inhibitors (alkyl phosphites) to prevent room-temperature curing. In FROMP, DHF or DHP acts simultaneously as inhibitor and comonomer, eliminating the need for phosphite additives in the degradable FROMP resin. Plastic material generated from degradable FROMP is crosslinked due to the high temperatures generated during FROMP curing.

In a second application, controlled drug release polymers may be prepared. Degradable polymers enable the sustained delivery of drugs over a time span of weeks but degradation of polymers allows complete excretion from human body. Thus, provided herein is the synthesis of water-soluble biocompatible polymers that are readily functionalized and only degraded in an acidic environment. These polymers may be used. e.g., for drug delivery to tumors.

A third application includes use in degradable engineering/consumer materials. A wide market has opened for the use of degradable plastics. Commonly used degradable plastics (e.g., polylactic acid, polyester, etc.), however, exhibit inadequate mechanical properties and extremely limited degradability outside of purpose-made industrial facilities. By comparison, copolymers of 2,3-dihydrofuran can be made with tunable physical properties and undergo rapid degradation under relatively mild acidic conditions while remaining stable under in-use conditions.

In one aspect, a polymer is provided that is the reaction product of a substituted or unsubstituted 2,3-dihydrofuran, a substituted or unsubstituted 2,3-dihydropyran, or a mixture of any two or more thereof with a substituted or unsubstituted cycloalkenyl monomer, or a mixture of any two or more thereof in the presence of a ring-opening metathesis catalyst.

In any of the above embodiments, the substituted or unsubstituted cycloalkenyl monomer is a substituted or unsubstituted norbornene monomer.

In any of the above embodiments, the cycloalkenyl monomer is a substituted or unsubstituted 1,5-cyclooctadiene. In some embodiments, the cycloalkenyl monomer is

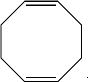

The polymer may be represented as:

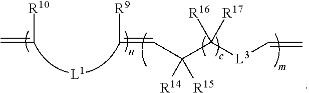

In the structure, L¹ is a substituted or unsubstituted alkyl or substituted or unsubstituted alkyenyl group; L³ is O, S, or NR¹⁸; R⁹, R¹⁰, R¹⁴, R¹⁵, R¹⁶, and R¹ are each individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, substituted or unsubstituted aryl, or substituted or unsubstituted heteroaryl, or any two or more of R¹, R², R³, R⁴, R⁵, R⁶, R⁷, R⁸, R⁹, R¹⁰, R¹⁴, R¹⁵, R¹⁶, and R¹⁷ may join together to form a ring; with the proviso that R⁹ and R¹⁰ are not joined to each other; R¹⁸ is H, substituted or unsubstituted alkyl, or substituted or unsubstituted haloalkyl; c is 1, 2, 3, 4, 5, 6, 7, or 8; m is 2 to 1.000,000; and n is 2 to 1,000.000.

The polymer may be represented as:

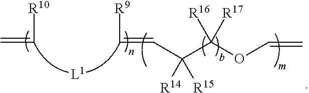

In the structure, L¹ is a substituted or unsubstituted alkyl or substituted or unsubstituted alkyenyl group; R⁹, R¹⁰, R¹⁴, R¹⁵, R¹⁶, and R¹⁷ are each individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, substituted or unsubstituted aryl, or substituted or unsubstituted heteroaryl, or any two or more of R¹, R², R³, R⁴, R⁵, R⁶, R⁷, R⁸, R⁹, R¹⁰, R¹⁴, R¹⁵, R¹⁶, and R¹⁷ may join together to form a ring; with the proviso that R⁹ and R¹⁰ are not joined to each other; b is 1 or 2; m is 2 to 1,000,000; and n is 2 to 1,000,000.

In some embodiments, the polymer may be represented as:

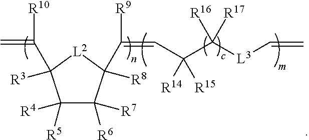

In the structure, L² is —C(R¹)(R²)—, —CH₂CH₂—, —N(R^{1a})— or —O—; L³ is O, S, or NR¹⁸; R¹, R^{1a}, R², R³, R⁴, R⁵, R⁶, R⁷, R⁸, R⁹, R¹⁰, R¹⁴, R¹⁵, R¹⁶, and R¹⁷ may each be individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, substituted or unsubstituted aryl, or substituted or unsubstituted heteroaryl, or any two or more of R¹, R², R³, R⁴, R⁵, R⁶, R⁷, R⁸, R⁹, R¹⁰, R¹⁴, R¹⁵, R¹⁶, and R¹⁷ may join together to form a ring, with the proviso that R⁹ and R¹⁰ are not joined to each other; R¹⁸ is H, substituted or unsubstituted alkyl, or substituted or unsubstituted haloalkyl; c is 1, 2, 3, 4, 5, 6, 7, or 8; m may be 2 to 1,000,000; and n may be 2 to 1,000.000.

In some embodiments, the polymer may be represented as:

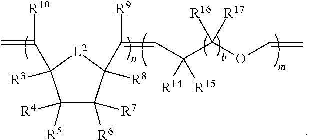

In the structure, L² is —C(R¹)(R²)—, —CH₂CH₂—, —N(R^{1a})— or —O—, R¹, R^{1a}, R², R³, R⁴, R⁵, R⁶, R⁷, R⁸, R⁹, R¹⁰, R¹⁴, R¹⁵, R¹⁶, and R¹⁷ may each be individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, substituted or unsubstituted aryl, or substituted or unsubstituted heteroaryl, or any two or more of R¹, R², R³, R⁴, R⁵, R⁶, R⁷, R⁸, R⁹, R¹⁰, R¹⁴, R¹⁵, R¹⁶, and R¹⁷ may join together to form a ring, with the proviso that R⁹ and R¹⁰ are not joined to each other; b may be 1 or 2; m may be 2 to 1,000,000; and n may be 2 to 1,000,000. In some embodiments, the polymer may be represented as

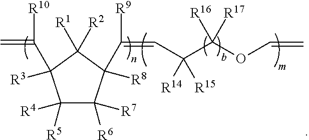

In some embodiments, R¹, R², R³, R⁴, R⁵, R⁶, R⁷, R⁸, R⁹, R¹⁰, R¹⁴, R¹⁵, R¹⁶, and R¹⁷ may each be individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, or substituted or unsubstituted heterocycle, or any two or more of R¹, R², R³, R⁴, R⁵, R⁶, R⁷, R⁸, R⁹, R¹⁰, R¹⁴, R¹⁵, R¹⁶, and R¹⁷ may join together to forma ring; b may be 1 or 2; m may be 2 to 3000; and n may be 2 to 1,000,000. The “m” and “n” are actually the repeat units and depending on desired molecular weight they can vary widely based upon the foregoing values. In some embodiments, R¹, R², R³, R⁴, R⁷, R⁸, R⁹, and R¹⁰ may be H. In some embodiments, n is 2 to 100.000. In some embodiments, n is 2 to 10.000. In some embodiments, n is 2 to 3,000. In some embodiments, m is 2 to 100,000. In some embodiments, m is 2 to 10,000. In some embodiments, m is 2 to 3,000.

In any of the above embodiments, R⁵ and R⁶ may join to form a ring.

In any of the above embodiments, R⁴, R⁵, R⁶, R⁷, may each individually be substituted or unsubstituted aryl.

The polymer, of course, is the product of the monomers used to form the polymer and the substitution thereon impacts much of the substitution (or lack thereof) on the polymer. In any of the above embodiments, the substituted or unsubstituted norbornene may be represented as:

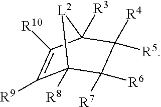

In this formula, L is —C(R¹)(R²)—, —N(R^{1a})— or —O—; R¹, R^{1a}, R², R³, R⁴, R⁵, R⁶, R⁷, R⁸, R⁹, and R¹⁰ may each be individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, or substituted or unsubstituted heteroaryl, or any two or more of R¹, R², R³, R⁴, R⁵, R⁶, R⁷, R⁸, R⁹, and R¹⁰ may join together to form a ring, with the proviso that R⁹ and R¹⁰ are not joined to each other; or R⁴ and R⁵ may join together to form an alkenyl group. In some embodiments, substituted or unsubstituted norbornene may be represented as

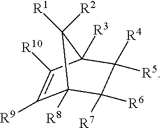

In some embodiments, R¹, R², R³, R⁴, R⁵, R⁶, R⁷, R⁸, R⁹, and R¹⁰ may each be individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, or substituted or unsubstituted heterocycle, or any two or more of R¹, R², R³, R⁴, R⁵, R⁶, R⁷, R⁸, R⁹, and R¹⁰ may join together to form a ring. In some embodiments, R¹, R^{1a}, R², R³, R⁴, R⁷, R⁸, R⁹ and R¹⁰ are H. In some embodiments, R^{1a} is H. In some embodiments, R^{1a} is unsubstituted alkyl. In some embodiments, R¹, R², R³, R⁴, R⁷, R⁸, R⁹, and R¹⁰ are H.

In any of the above embodiments, R⁵, R⁶, or both R⁵ and R⁶ may be a polyethylene glycol moiety with 2-25,000 repeating units, or a cross-linkable group. In some embodiments, R⁵, R⁶, or both R⁵ and R⁶ may be a polyethylene glycol moiety with 2-1,000 repeating units, or a cross-linkable group. In some embodiments, R⁵, R⁶, or both R⁵ and R⁶ may be a polyethylene glycol moiety with 2-100 repeating units, or a cross-linkable group. In some embodiments, R⁵, R⁶, or both R⁵ and R⁶ may be a polyethylene glycol moiety with 2-30 repeating units, or a cross-linkable group. For example, R⁵, R⁶, or both R⁵ and R⁶ may be (meth)acrylate or (meth)acrylamide moiety.

In some embodiments, the substituted or unsubstituted norbornene may be of formula (i.e. where R⁵ and R⁶ have joined):

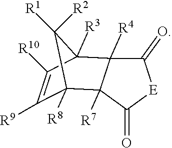

In this formula, E is O, NR¹¹ or CR¹²₂; and R¹¹ and R¹² are individually H, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, substituted or unsubstituted aryl, or substituted or unsubstituted heteroaryl. In some embodiments, E is O, NR¹¹ or CR¹²₂; and R¹¹ and R¹² are individually H, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, or substituted or unsubstituted heterocycle. In some embodiments, in this formula, E is O, NR¹¹ or CR¹²₂; and R¹¹ and R¹² are individually H, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, or substituted or unsubstituted heterocycle. In some embodiments, R¹¹, R¹², or both R¹¹ and R¹² may be a polyethylene glycol moiety with 2-25.000 repeating units.

Illustrative substituted or unsubstituted norbornenes include, but are not limited to:

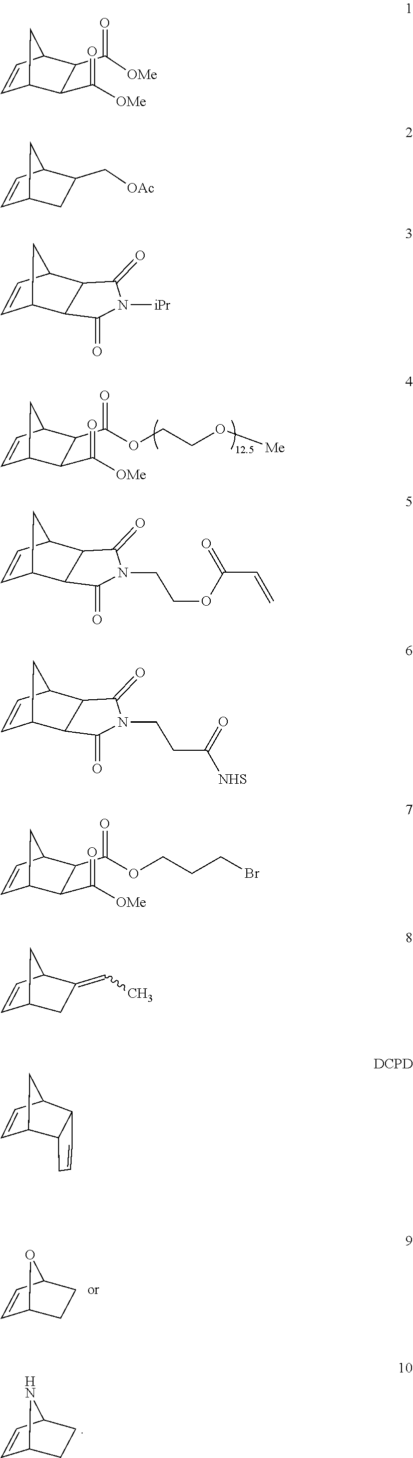

In any of the above embodiments, the substituted or unsubstituted 2,3-dihydrofuran or the 2,3-dihydropyran may be a compound represented as:

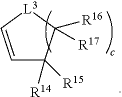

In this formula, L³ is O, S, or NR¹⁸; R¹⁴, R¹⁵, R¹⁶, and R¹⁷ may each be individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycle, substituted or unsubstituted aryl; any two or more of R¹⁴, R¹⁵, R¹⁶, and R¹⁷ may join together to form a ring; R¹⁸ is H, substituted or unsubstituted alkyl, or substituted or unsubstituted haloalkyl; and c is 1, 2, 3, 4, 5, 6, 7, or 8.

In any of the above embodiments, the substituted or unsubstituted 2,3-dihydrofuran or the 2,3-dihydropyran may be a compound represented as:

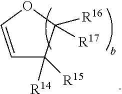

In this formula, R¹⁴, R¹⁵, R¹⁶, and R¹⁷ may each be individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycle, substituted or unsubstituted aryl; any two or more of R¹⁴, R¹⁵, R¹⁶, and R¹⁷ may join together to form a ring; and b may be 1 or 2.

In any of the above embodiments, the ring-opening metathesis catalyst (e.g., ROMP catalyst) is a transition metal catalyst. Illustrative ring-opening metathesis catalysts include, but are not limited to catalysts as depicted below, and as described in Grubbs et al., Acc. Chem. Res. 1995, 28, 446452; U.S. Pat. No. 5,811,515; Schrock et al., Organometallics (1982) 1 1645; Gallivan et al., Tetrahedron Letters (2005) 46:2577-2580; Furstner et al., J. Am. Chem. Soc. (1999) 121:9453; Chem. Eur. J. (2001) 7:5299; and “Olefin Metathesis and Metathesis Polymerization” by K. J. Ivin and J. C. Mol; the entire contents of each of which are incorporated herein by reference. In some embodiments, the ring-opening metathesis catalyst (e.g., ROMP catalyst) is a tungsten (W), molybdenum (Mo), chromium (Cr), or ruthenium (Ru) catalyst. In some embodiments, the ring-opening metathesis catalyst (e.g., ROMP catalyst) is a tungsten (W), molybdenum (Mo), or ruthenium (Ru) catalyst.

In some embodiments, the ring-opening metathesis catalyst may be a molybdenum-based metathesis catalyst. In some embodiments, the ring-opening metathesis catalyst may be

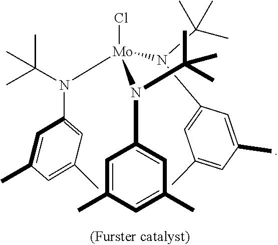

In some embodiments, the ring-opening metathesis catalyst may be a chromium-based metathesis catalyst. In some embodiments, the ring-opening metathesis catalyst may be

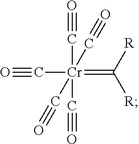

wherein each R is independently —OMe or phenyl.

In some embodiments, the ring-opening metathesis catalyst may be a ruthenium-based metathesis catalyst. This may include, where the ring-opening metathesis catalyst may be a ruthenium bipyridine-based metathesis catalyst. In some embodiments, the ring-opening metathesis catalyst may be a Grubbs catalyst. In some embodiments, the ring-opening metathesis catalyst may be a RuCl₃/alcohol mixture. In some embodiments, the ring-opening metathesis catalyst may be bis(cyclopentadienyl)dimethylzirconium(IV). In some embodiments, the ring-opening metathesis catalyst may be dichloro[1,3-bis(2,6-isopropylphenyl)-2-imidazolidinylidene](benzylidene)(tricyclohexylphosphine)ruthenium(II). In some embodiments, the ring-opening metathesis catalyst may be dichloro[1,3-Bis(2-methylphenyl)-2-imidazolidinylidene](benzylidene)(tricyclohexylphosphine) ruthenium(II). In some embodiments, the ring-opening metathesis catalyst may be dichloro[1,3-bis(2,4,6-trimethylphenyl)-2-imidazolidinylidene][3-(2-pyridinyl)propylidene]ruthenium(II). In some embodiments, the ring-opening metathesis catalyst may be dichloro(3-methyl-2-butenylidene)bis (tricyclopentylphosphine)ruthenium(II). In some embodiments, the ring-opening metathesis catalyst may be dichloro[1,3-bis(2-methylphenyl)-2-imidazolidinylidene](2-isopropoxypheny-lmethylene)ruthenium(II) (Grubbs C571). In some embodiments, the ring-opening metathesis catalyst may be dichloro(benzylidene)bis(tricyclohexylphosphine)ruthenium(II) (Grubbs I). In some embodiments, the ring-opening metathesis catalyst may be dichloro[1,3-bis(2,4,6-trimethylphenyl)-2-imidazolidinylidene](benzyliden-e)(tricyclohexylphosphine) ruthenium(II) (Grubbs II). In some embodiments, the ring-opening metathesis catalyst may be and dichloro[1,3-bis(2,4,6-trimethylphenyl)-2-imidazolidinylidene](benzyliden-e)bis(3-bromopyridine)ruthenium(II) (Grubbs III). In some embodiments, the ring-opening metathesis catalyst may be

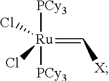

wherein X is OR′, NR′₂, SR′, or SeR′; R′ is substituted or unsubstituted alkyl, substituted or unsubstituted cycloalkyl, substituted or unsubstituted aryl, or substituted or unsubstituted heteroaryl; and Cy is cyclohexyl. In some embodiments, the ring-opening metathesis catalyst may be

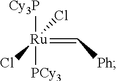

wherein Cy is cyclohexyl. In some embodiments, the ring-opening metathesis catalyst may be

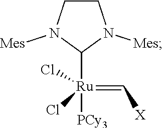

wherein X is OR′, NR′₂, SR′, or SeR′; R′ is substituted or unsubstituted alkyl, substituted or unsubstituted cycloalkyl, substituted or unsubstituted aryl, or substituted or unsubstituted heteroaryl; Mes is mesitylene and Cy is cyclohexyl. In some embodiments, the ring-opening metathesis catalyst may be

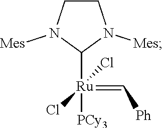

wherein Mes is mesitylene and Cy is cyclohexyl. In some embodiments, the ring-opening metathesis catalyst may be

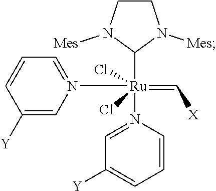

wherein X is OR′, NR′₂, SR′, or SeR′; R′ is substituted or unsubstituted alkyl, substituted or unsubstituted cycloalkyl, substituted or unsubstituted aryl, or substituted or unsubstituted heteroaryl; each Y is independently H, F, Cl, Br, or I; and Mes is mesitylene. In some embodiments, the ring-opening metathesis catalyst may be

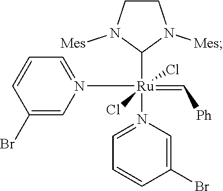

wherein Mes is mesitylene. In some embodiments, the ring-opening metathesis catalyst may be

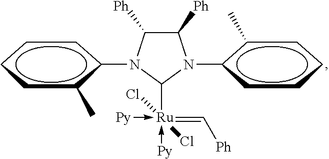

wherein Py is pyridine and Ph is phenyl. In some embodiments, the ring-opening metathesis catalyst may be

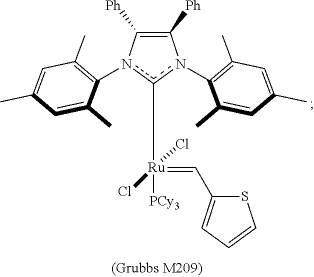

wherein Cy is cyclohexyl. In some embodiments, the ring-opening metathesis catalyst may be

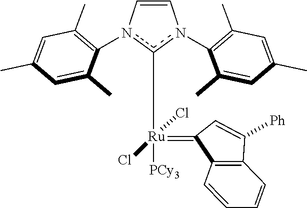

(M203); wherein Cy is cyclohexyl. In some embodiments, the ring-opening metathesis catalyst may be

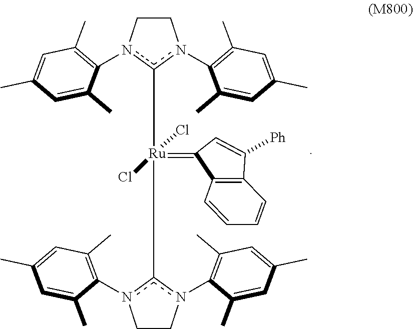

In some embodiments, the ring-opening metathesis catalyst may be

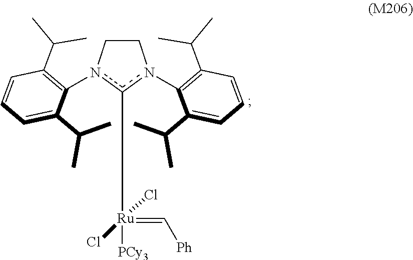

wherein Cy is cyclohexyl. In some embodiments, the ring-opening metathesis catalyst may be

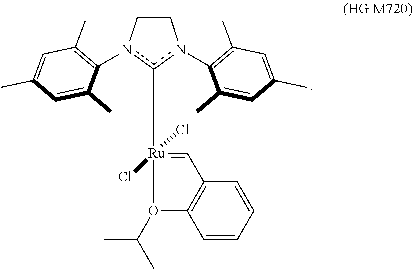

In some embodiments, the ring-opening metathesis catalyst may be

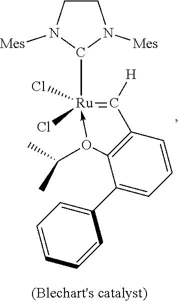

wherein Mes is mesitylene. In some embodiments, the ring-opening metathesis catalyst may be

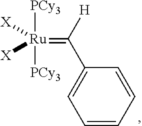

wherein each X is independently Cl, Br or I; and Cy is cyclohexyl. In some embodiments, the ring-opening metathesis catalyst may be

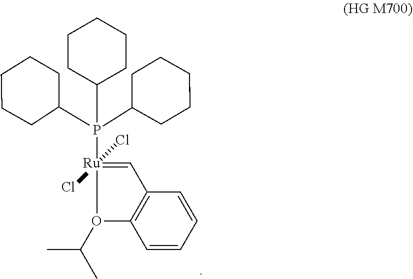

In some embodiments, the ring-opening metathesis catalyst may be

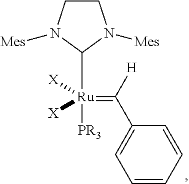

wherein Mes is mesitylene; each X is independently Cl, Br or I; and each R is independently cyclohexyl, phenyl, or benzyl. In some embodiments, the ring-opening metathesis catalyst may be

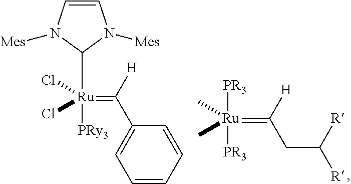

wherein each R is independently cyclohexyl or phenyl, and each R′ is independently methyl or phenyl, Mes is mesitylene, and Cy is cyclohexyl. In some embodiments, the ring-opening metathesis catalyst may be

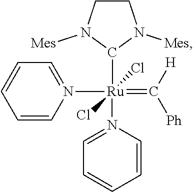

wherein Mes is mesitylene. In some embodiments, the ring-opening metathesis catalyst may be

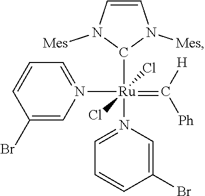

wherein Mes is mesitylene. In some embodiments, the ring-opening metathesis catalyst may be

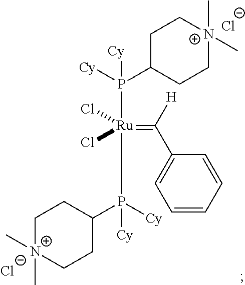

wherein Cy is cyclohexyl. In some embodiments, the ring-opening metathesis catalyst may be

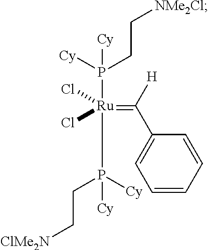

wherein Cy is cyclohexyl. In some embodiments, the ring-opening metathesis catalyst may be

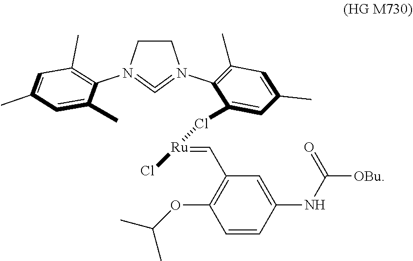

In some embodiments, the ring-opening metathesis catalyst may be

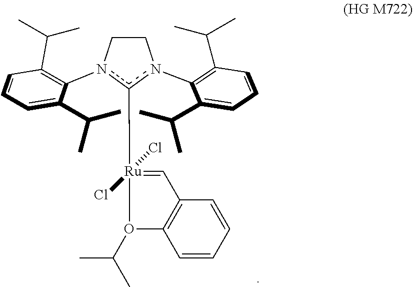

In some embodiments, the ring-opening metathesis catalyst may be

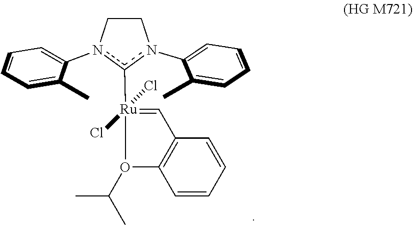

In some embodiments, the ring-opening metathesis catalyst may be

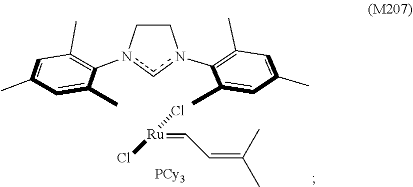

wherein Cy is cyclohexyl. In some embodiments, the ring-opening metathesis catalyst may be

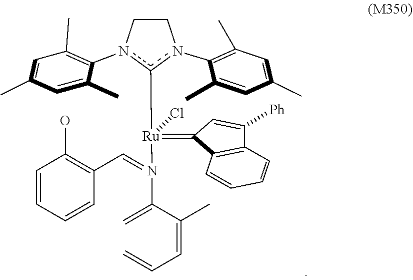

In some embodiments, the ring-opening metathesis catalyst may be

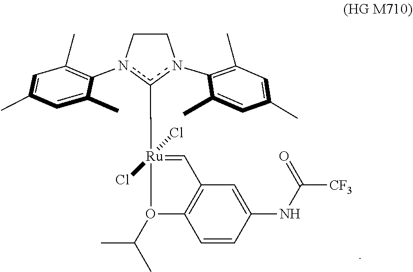

In some embodiments, the ring-opening metathesis catalyst may be

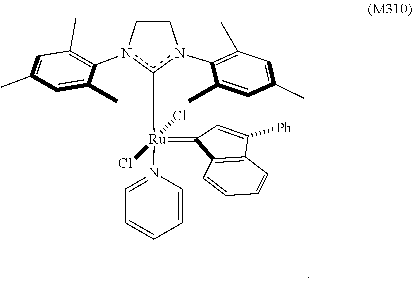

In some embodiments, the ring-opening metathesis catalyst may be

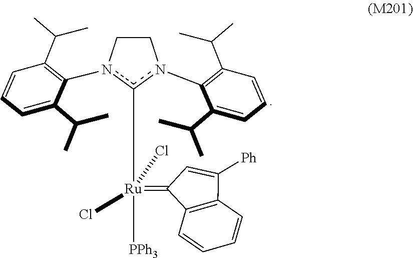

In some embodiments, the ring-opening metathesis catalyst may be

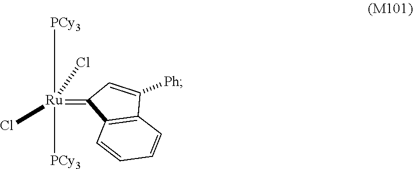

wherein Cy is cyclohexyl. In some embodiments, the ring-opening metathesis catalyst may be

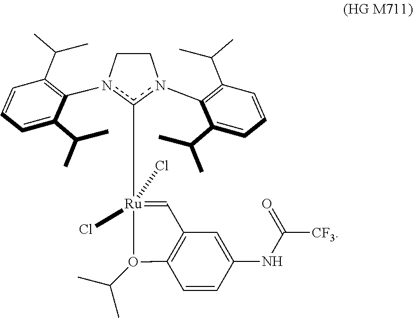

In some embodiments, the ring-opening metathesis catalyst may be

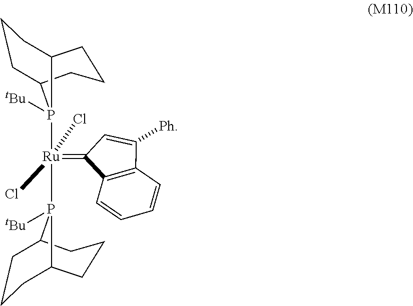

In some embodiments, the ring-opening metathesis catalyst may be

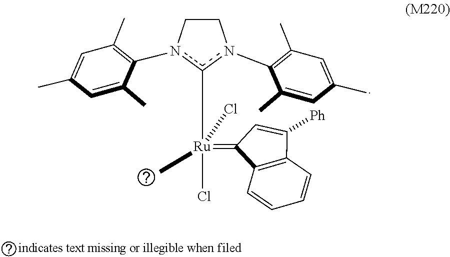

In some embodiments, the ring-opening metathesis catalyst may be

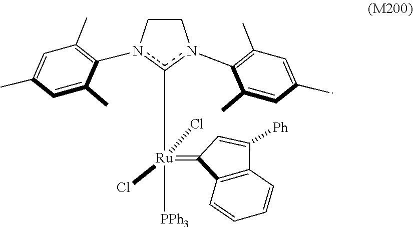

In some embodiments, the ring-opening metathesis catalyst may be

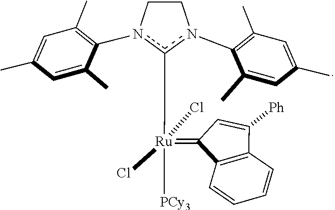

wherein Cy is cyclohexyl. In some embodiments, the ring-opening metathesis catalyst may be

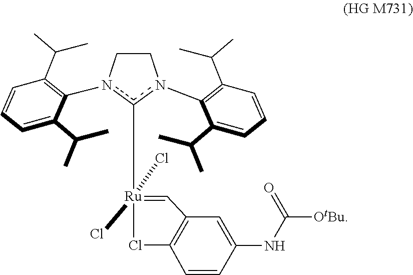

In some embodiments, the ring-opening metathesis catalyst may be

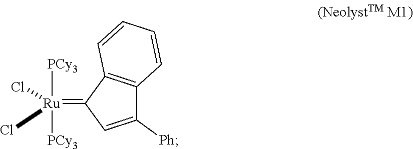

wherein Cy is cyclohexyl.

In another aspect, a process is provided of preparing any of the polymers described herein, where the process include contacting a substituted or unsubstituted 2,3-dihydrofuran, a substituted or unsubstituted 2,3-dihydropyran, or a mixture of any two or more thereof with a substituted or unsubstituted cycloalkenyl monomer, or a mixture of any two or more thereof in the presence of a ring-opening metathesis catalyst. In some embodiments, the substituted or unsubstituted cycloalkenyl monomer is a substituted or unsubstituted norbornene monomer. Each of the 2,3-dihydrofurans, 2,3-dihydropyrans, cycloalkenyl monomers and norbornene monomers is as described herein and above in detail. In some embodiments, polymerizations may be carried out either in solution or neat. Common solvents include MEK, chloroform, methylene chloride, acetonitrile, toluene, DMF, diglyme, dioxane, THF, and DMSO. Following polymerization, ruthenium catalysts can be removed by treating with acyclic vinyl ethers (e.g., ethyl vinyl ether, butyl vinyl ether, or the like) or by treating with an alkaline solution of hydrogen peroxide (Hydrogen peroxide solution mixed with a base, for example NaOH, KOH, Na₂CO₃, or the like).

In another aspect, a process is provided for preparing a polymer and the process includes contacting an enol ether monomer with a norbornene monomer in the presence of a ring-opening metathesis catalyst and performing a frontal ring opening metathesis polymerization.

In a further aspect, a process of preparing a telechelic polymer or oligomer is provided that includes contacting an enol ether monomer with a cyclopentadiene or dicyclopentadiene monomer in the presence of a ring-opening metathesis catalyst.

The present invention, thus generally described, will be understood more readily by reference to the following examples, which are provided by way of illustration and are not intended to be limiting of the present invention.

### EXAMPLES

Example 1: DHF-Norbornene Copolymerization. Copolymerization of DHF was explored with several NBE derivatives using the simple procedure typical of living ROMP. First, copolymerization with exonorbornene dimethyl ester 1 was explored (Scheme 1). DHF and 1 were dissolved in THF (0.15 M for each monomer) at a 1:1 molar ratio, and the solution was initiated under inert atmosphere at room temperature by adding 0.02 equivalents of 3rd generation bispyridine Grubbs catalyst (G3) to target a total degree of polymerization (DP) of 100. Due to the reduced reactivity of in situ generated Fischer carbenes, the copolymerization was considerably slower than typical homopolymerization of NBEs, but >90% conversion of 1 was still achieved within 2 hours (h). Excess ethyl vinyl ether was then added and the solution was stirred for 5 min to cleave the catalyst from the active chain end and terminate the polymerization. Although we previously showed that the addition of linear vinyl ether at the end of DHF homopolymerization resulted in decreased polymer MW due to secondary enol ether metathesis reactions, for the copolymerization, no change in the MW or dispersity (Ð) of the NBE-DHF copolymer was observed following the addition of excess vinyl ether. After quenching, a white, rubbery polymer was isolated by precipitation into methanol and centrifugation.

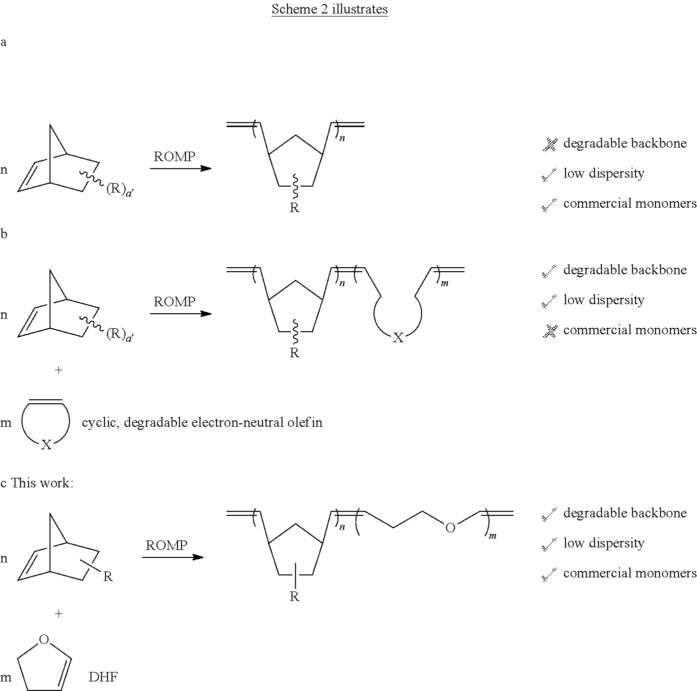

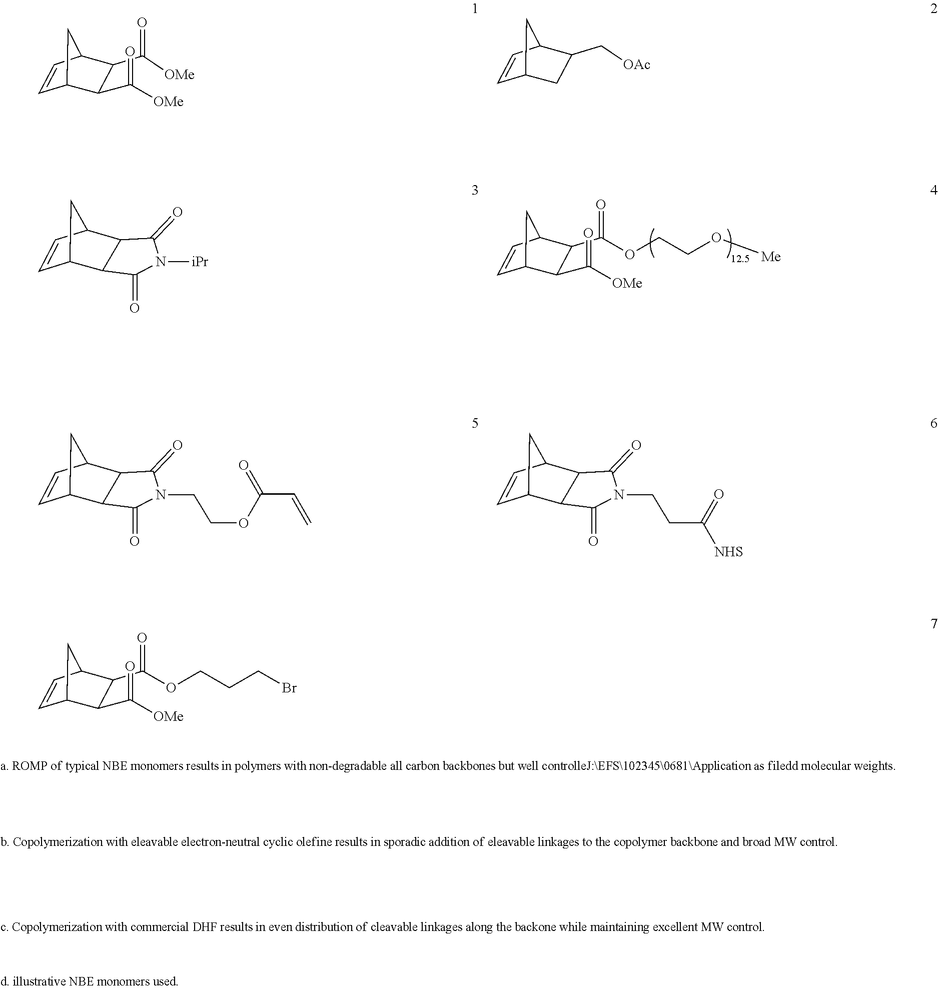

TABLE 1
ROMP Copolymers of 2,3-dihydrofuran with norbornenes.^{a}

| | | | | | Comonomer | | | | |
|---|---|---|---|---|---|---|---|---|---|
| | | | | Polymerization | Incorporation | Conv. | M_{n, MALLS} | M_{n, theo} | |
| Polymer | NBE | DP | [NBE]₀:[DHF]₀:[G3]₀ ^{b} | time (h) | (NBE:DHF) ^{c} | (%)^{d} | (kDa) ^{e} | (kDa) ^{f} | Ð ^{g} |
| P1 | 1 | 100 | 50:50:1 | 2 | 100:75 | 94 | 13.4 | 13.3 | 1.05 |
| P2 | 1 | 200 | 100:100:1 | 2 | 100:78 | 94 | 23.7 | 26.5 | 1.09 |
| P3^{h} | 1 | 600 | 300:300:1 | 3 | 100:67 | 76 | 65.2 | 58.7 | 1.04 |
| P4 | 2 | 200 | 100:100:1 | 0.75 | 100:45 | >95 | 21.3 | 19.5 | 1.12 |
| P5 | 3 | 200 | 100:100:1 | 10 | 100:82 | 78 | 19.3 | 20.6 | 1.03 |
| P6 | 3 | 150 | 100:50:1 | 10 | 100:43 | 79 | 18.0 | 18.7 | 1.09 |
| P7 | 4 | 200 | 100:100:1 | 2.75 | 100:96 | 95 | 83.6 | 89.0 | 1.07 |
| P8 | 5 | 200 | 100:100:1 | 2 | 100:72 | 65 | 16.1 | 21.0 | 1.12 |

^{a}ROMP was performed under an N₂ atmosphere at room temperature in THF with [NBE]₀ = 0.15M.
^{b} Initial equivalents of NBE:DHF:Grubbs initiator.
^{c} Ratio of monomers incorporated into copolymers, determined by ¹H NMR spectroscopy in CDCl₃.
^{d}Conversion of NBE determined by ¹H NMR spectroscopy.
^{e} Determined by GPC MALLS analysis in THF.
^{f} Theoretical Mₙ based on NBE conversion and composition determined by ¹H NMR.
^{g} M_{w}/Mₙ.
^{h}Polymerized with 5 equiv. 3-bromopyridine.

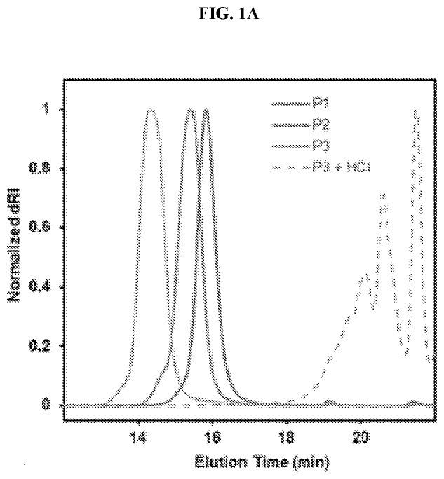

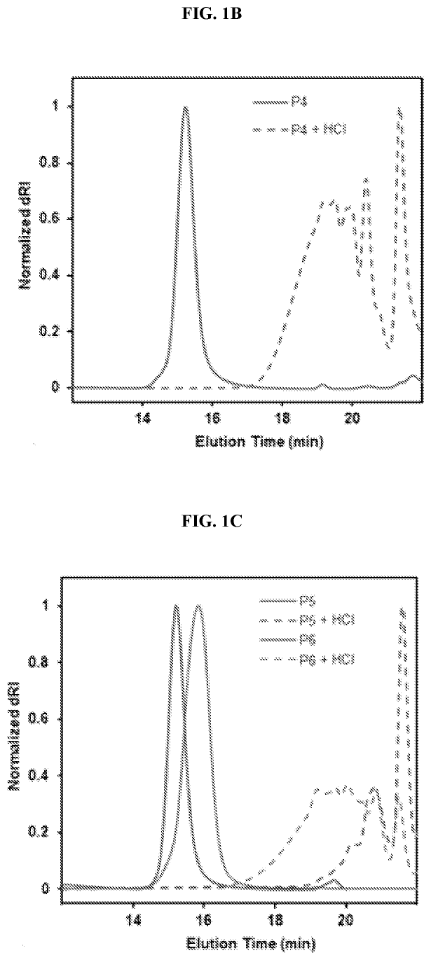

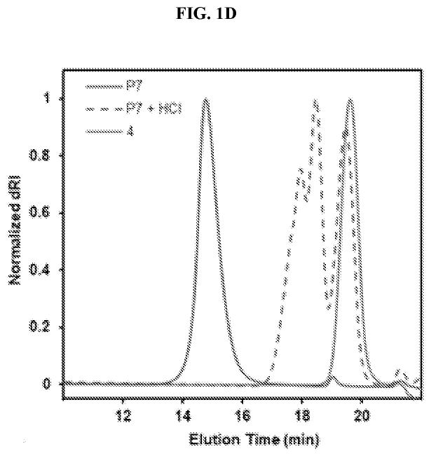

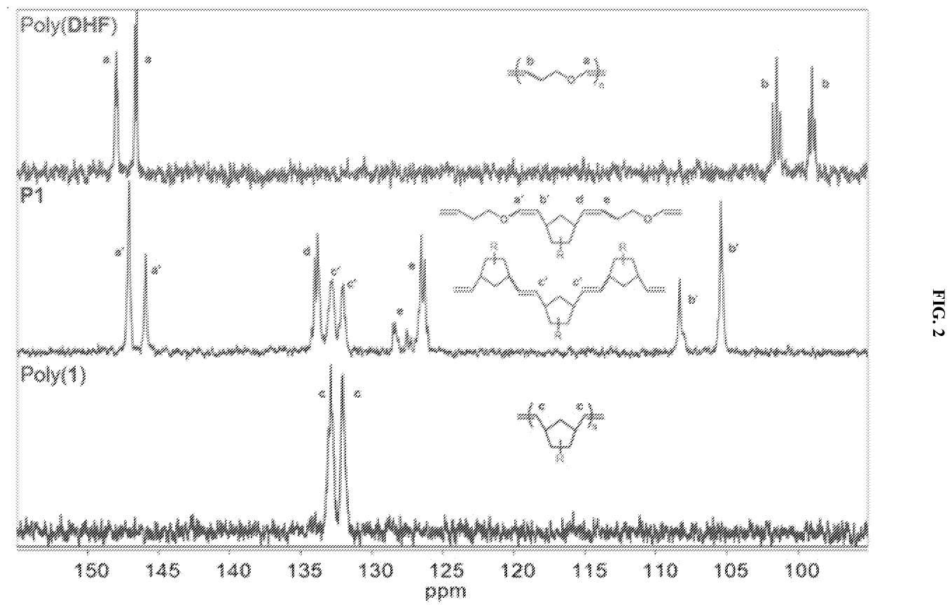

Gel permeation chromatography (GPC) analysis of the copolymer showed a peak with Ð<1.1 and Mₙ=13.4 kDa that closely matched the theoretical value, indicating controlled polymerization with minimal chain transfer on backbone olefins (Table 1, entry P1, FIG. 1a). ¹H NMR spectroscopy showed a composition of NBE:DHF=100:78 for the isolated polymer. Only sets of olefinic peaks corresponding to E- and Z-isomers of 1-DHF heterodyads and 1-1 homodyads were observed in the ¹³C NMR spectrum (FIG. 2). No DHF-DHF homodyads were observed, indicating that DHF units are distributed throughout the copolymer chain rather than forming a poly(DHF)-rich block.

The targeted total DP was increased while keeping NBE:DHF feed ratio at 1:1. At a targeted DP of 200, the copolymer exhibited similarly low dispersity and expected MW (Table 1, Entry P2, FIG. 1a). But when targeting a high total DP of 600, although >90% conversion was still achieved, a broader GPC peak was observed presumably due to chain transfer. To suppress chain transfer, 5 equiv. 3-bromopyridine were added to the polymerization mixture prior to initiation, resulting in a copolymer of Ð=1.04 and Mₙ=65 kDa (Table 1, entry P3, FIG. 1a).

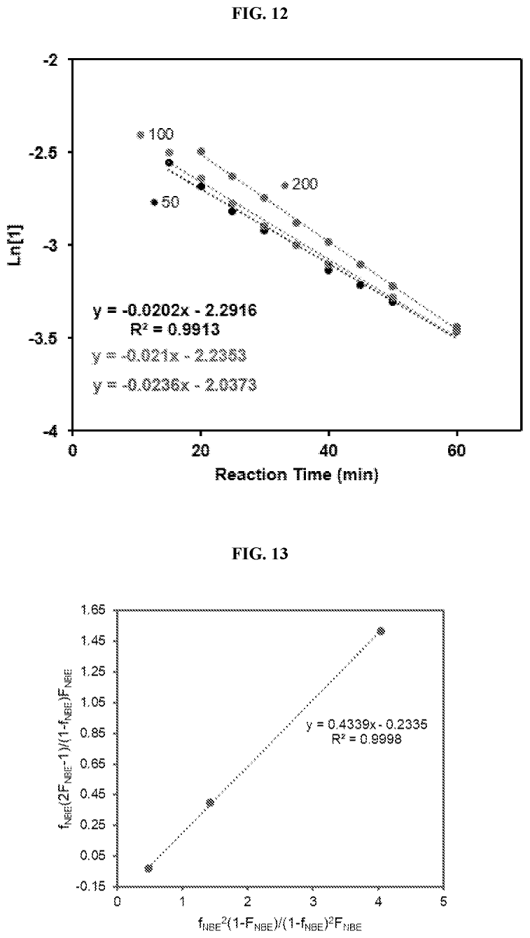

NBE conversion was monitored by ¹H NMR spectroscopy with [DHF]₀=0.15 M and [1]₀=0.075, 0.15, or 0.3 M. The copolymerization exhibited zero and first order kinetics with respect to DHF and 1, respectively (FIG. 12). This observation suggests that the addition of DHF to Grubbs catalyst during copolymerization is rapid, and subsequent reaction of the Fischer carbene with NBE is the rate limiting step. In addition, only NMR signals corresponding to the Fischer carbene were observed during the copolymerization, indicating that the resting state of the catalyst is the Fischer carbene. The reactivity ratios of the two monomers were also calculated to be rESTER=0.43 and rDHF=0.23. The small product of the reactivity ratios (rESTER rDHF=0.10) suggests a moderate degree of monomer alternation in this co-polymerization. The even incorporation of degradable DHF units throughout the polymer chain is highly desired to prevent the formation of long nondegradable poly(NBE) segments, and distinguishes this method from previous copolymerization approaches using electron-neutral cyclic olefins.

Each of the copolymers P1, P2, and P3 were rapidly degraded in THF solution with the addition of dilute HCl (˜20 mM). GPC analysis of the degraded copolymers showed complete degradation of polymer within 30 min into small molecule species with no detectable residual polymer (FIG. 1a, S4). The lack of polymeric degradation products also confirms the uniform distribution of DHF units throughout the copolymer.

Mono-substituted NBEs should have faster propagation than disubstituted NBEs. Indeed, copolymerization of DHF with a mono-substituted NBE, 2, exhibited faster polymerization rate than with 1 under identical conditions, reaching >95% NBE conversion in 45 min at a total targeted DP of 200. The resulting copolymer exhibited a low Ð of 1.12 and M matching the theoretical value (Table 1, entry P4). The high reactivity of 2 resulted in higher incorporation of NBE in the co-polymer than the feed ratio, and the copolymer had a composition of 2:DHF=100:45. Despite the reduced incorporation of degradable units, the copolymer was still fully hydrolyzed to small molecule and oligomeric species (FIG. 1b). In comparison, the copolymerization of the same NBE 2 with a silyl ether-containing cyclic olefin gave a similar MW distribution and only partial reduction of the polymer MW upon degradation, indicating significant NBE homopropagation without a more controlled copolymerization in that case. The high reactivity of cyclic enol ethers toward the Grubbs alkylidenes is a distinct advantage for this copolymerization strategy compared to other reported degradable ROMP comonomers. It attenuates the high reactivity of fast-propagating NBEs and efficiently interrupts their homopropagation.

NBE imides are among the most widely used monomers for living ROMP, and so -iPr imide 3 was explored for copolymerization with DHF. Under identical conditions, the copolymerization of 3 is slower than disubstituted ester NBE 1, reaching 78% conversion in 10 h for total targeted DP of 200. Similar to the copolymers of 1 and DHF, P5 exhibited Ð<1.1, controlled Mₙ close to the theoretical value, and a monomer composition of 3:DHF around 100:80. (Table 1, entry P5). P5 was also completely degraded upon hydrolysis with HCl in THF (FIG. 1c).

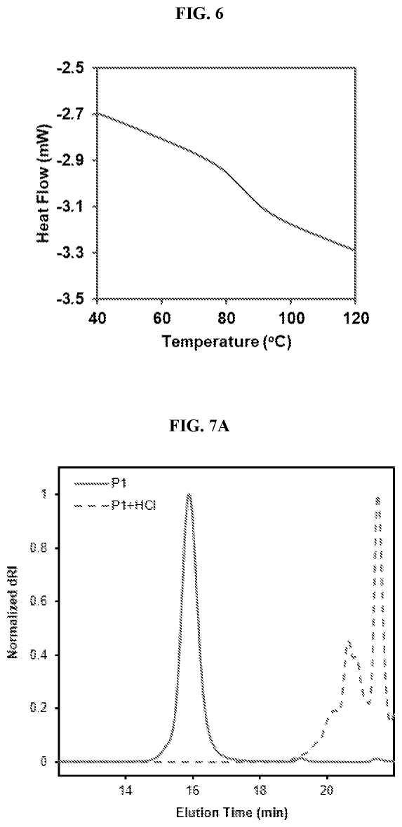

To examine the impact of monomer feed ratio on the copolymerization, [3]₀:[DHF]₀ was changed to 100:50. Consistent with our observation that the rate of polymerization is zero order with respect to DHF, the rate was unchanged. The resulting copolymer remained narrow-disperse and had a composition of 3:DHF about 100:45 as expected (Table 1, Entry P6). The reduced composition of DHF in P6 resulted in a higher T_{g} of 86° C. than that of P5 (T_{g}=69° C.) (FIGS. 5 and 6). The reduced density of hydrolyzable linkages in P6 also resulted in degradation products that include poly(3) oligomers (FIG. 1c). For reference, poly(3) with DP=10 elutes at 17.75 min in GPC.

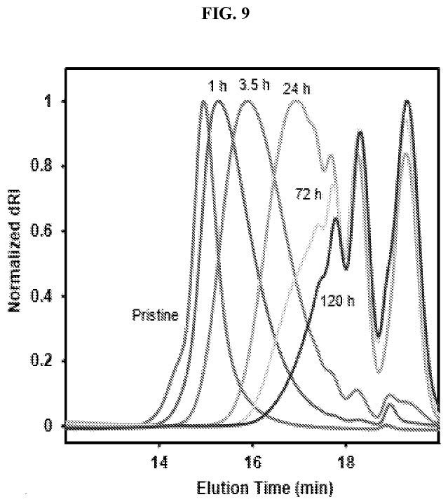

Degradable polymers are highly desired for many biomedical applications. To this end, a water-soluble NBE bearing an oligo(ethylene glycol) side chain of 550 Da was explored, 4 (Scheme 1), using the faster propagating NBE diester substitution pattern. The copolymerization of DHF and 4 at [4]₀:[DHF]₀:[G3]₀=100:100:1 required 2.75 h to reach 95% conversion of 4, resulting in a copolymer with Mₙ=85.2 kDa and Ð=1.07 and a composition of 50% 4 50% DHF (Table 1, entry P7). P7 was water soluble and stable in PBS buffer at physiological pH 7.4, exhibiting no degradation even after 2 days. However, upon addition of 5% acetic acid, the copolymer slowly hydrolyzed over several days (FIG. 9). This controlled, stimulus-responsive hydrolysis is ideal for biological applications requiring a stable material that can be degraded after use. P7 is also rapidly degraded by HCl in THF into small molecules, corresponding to mostly monomer, dimer, and trimer (FIG. 1D).

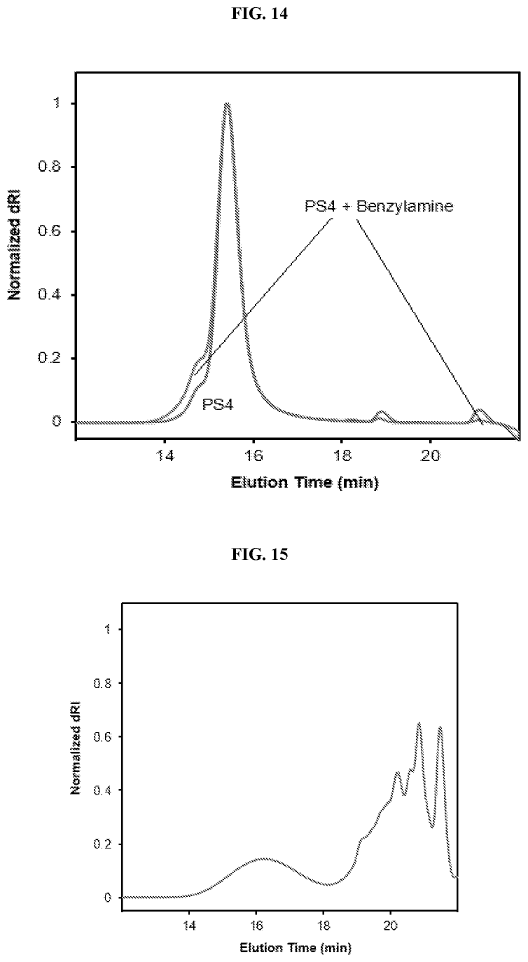

To incorporate useful functional groups in the degradable copolymers and allow facile functionalization, NBEs were synthesized with pendent acrylate (5), NHS-ester (6), and alkyl bromide (7) groups, which can be easily functionalized post-polymerization (Scheme 2). Terpolymers of each of these functional monomers with DHF and 1 or 4 were readily synthesized with low dispersities and controlled molecular weights (Table 2, Entries PS1-4). The synthetic handles incorporated into these terpolymers can be utilized to attach functional groups or molecules for use in imaging or drug delivery applications. For example, terpolymers of 6 with DHF and either 1 or 4 can be readily labeled with secondary amines (FIG. 14). Additionally, acrylates are not compatible in typical controlled ROMP due to its selective cross metathesis with electron-neutral olefins. But copolymerization of 5 and DHF generated low dispersity copolymers (Table 1, entry P8). In comparison, homopolymerization of 5 resulted in a very broad MWD (Ð=4.2). The low reactivity of the Fischer carbene toward acrylates accounts for the observed compatibility of 5 in the DHF copolymerization. The straightforward incorporation of pendent acrylic groups provides a convenient means to crosslink the degradable copolymers postpolymerization.

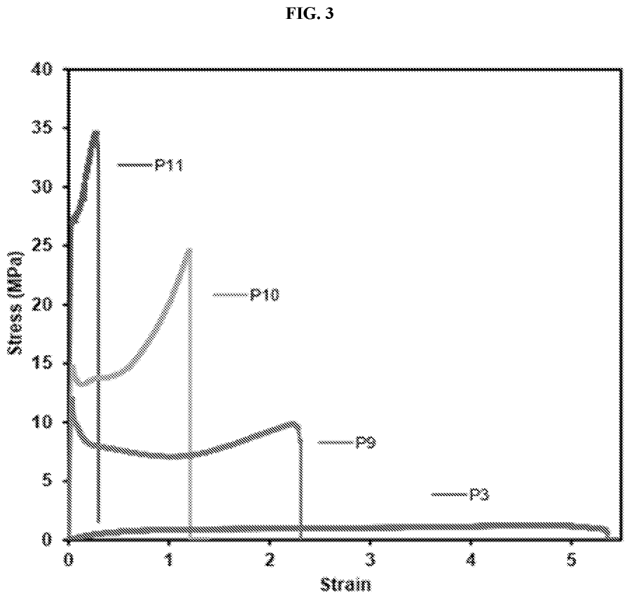

Mechanical properties are an important consideration for developing degradable polymers that can replace their non-degradable counterparts. P3 with the determined composition of 1:DHF=100:70 exhibited a low T_{g} of 21° C., resulting in a viscoelastic material with elastic modulus (E) of 2.3 MPa, ultimate tensile strength (UTS) of 1.24 MPa, and strain at break over 500%. Addition of 5 to the 1/DHF monomer feed in a ratio of 1:5:DHF=290:10:300 yielded a terpolymer that was readily crosslinked by curing with radical initiator azobisisobutyronitrile at 70° C. The crosslinking led to a material, P9, with considerably enhanced mechanical properties with E=600 MPa, UTS=9.7 MPa, and strain at break of 230% (FIG. 3). These properties are similar to those of low-density polyethylene, showing promise of these ROMP copolymers as degradable alternatives to common nondegradable polymers. The mechanical properties of the crosslinked copolymer can be tuned by altering the crosslinking density. For example, increasing the 5 loading to a monomer feed ratio 1:5:DHF=270:30:300 yielded a stronger material, P10, upon crosslinking with E=610 MPa, UTS=25 MPa, and strain at break of 100%, properties similar to high-density polyethylene (FIG. 3). These crosslinked polymers can be still degraded into a mixture of soluble polymers and small molecules upon treatment with HCl in THF (FIG. 15). Stiffer and stronger polymers can also be generated using glassy copolymers of 3 with DHF. Copolymer P11 with initial monomer loading of 3:DHF=300:300 exhibits E=1.04 GPa. UTS=34.9 MPa, and strain at break of 27%. The wide range of mechanical properties from the crosslinked or uncrosslinked NBE-DHF copolymers demonstrate another attractive feature of this copolymerization strategy for developing degradable polymers.

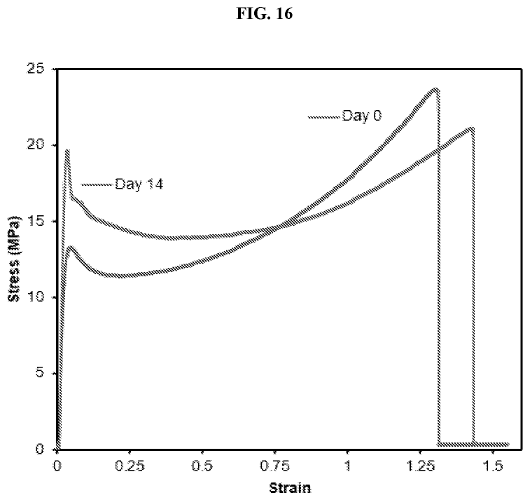

Like poly(DHF), NBE-DHF copolymers exhibit surprising stability in the solid state. After storing P3 in air for 14 days, the sample exhibited only 20% reduction in molecular weight by GPC (Table 3). Similarly, P10 UTS and elongation at break showed negligible change after 14 days (FIG. 16). This demonstrates that while these polymers can readily degrade over short timescales under acidic conditions, they maintain an adequate shelf-life for consumer applications.

It has been demonstrated the facile copolymerization of DHF with an array of NBE monomers. By harnessing the rapid reaction of electron-rich enol ethers with the propagating Ru alkylidene (appending ring-opened NBE), NBE homopropagation is suppressed, allowing even distribution of DHF along the polymer chain to result in fully degradable copolymers with controlled MWs, low dispersities, and high conversions. Interestingly, this copolymerization was found to be first order in NBE but zero order in DHF, and thus the structure of NBE was found to control the copolymerization rate. Copolymers were also synthesized that are water-soluble, functionalizable, or crosslinkable. All the DHF copolymers can be completely hydrolyzed into small molecules or oligomers under acidic conditions.

This facile strategy for the synthesis of degradable ROMP polymers has several distinct advantages over other approaches: 1) simplicity of add commercially available DHF to NBEs under otherwise common living ROMP conditions: 2) the even distribution of degradable linkages leading to complete polymer degradation, 3) retained living polymerization characteristics, 4) generality to take advantage of many NBEs developed for living ROMP. The reported strategy upgrades the power of widely-used living ROMP. The new family of degradable copolymers with controlled characteristics, tunable properties, and facile degradation will open doors to applications ranging from nanolithography to drug delivery to environmentally benign plastic materials.

General Information. Reagents were purchased from commercial vendors and used as received except where otherwise noted. Catalyst G3 [Angewandte Chemie International Edition 2002, 41(21), 4035-4037] was prepared as described previously. Norbornene monomers 1 [Journal of the American Chemical Society 2017,139 (48), 17683-17693], 2 ACS Macro Letters 2018, 7 (6), 656-661; Helvetica Chimica Acta 1993, 76 (1), 248-258], 3, and 5 [Macromolecular Rapid Communications 2015, 36 (17), 1578-1584] as well as amine-functional rhodamine B [Organic Letters 2003, 5 (18), 3245-3248] were prepared according to literature precedent. Flash column chromatography was performed using F60 silica gel (40-63 μm, 230-400 mesh, 60 Å) purchased from Silicycle. Analytical thin-layer chromatography (TLC) was carried out on 250 μm 60-F254 silica gel plates purchased from EMD Millipore, and visualization was effected by observation of fluorescence quenching with ultraviolet light and staining with either p-anisaldehyde or KMnO₄ as a developing agent.

Proton nuclear magnetic resonance (¹H NMR) and carbon nuclear magnetic resonance (¹³C NMR) spectra were recorded on Varian Inova 500, Varian Mercury 400, or Varian Inova 300 spectrometers operating respectively at 500, 400, and 300 MHz for ¹H and at 125, 100, and 75 MHz for ¹³C. Chemical shifts are reported in parts per million (ppm)relative to residual protonated solvent for ¹H (CHCl₃=δ 7.26) and relative to carbon resonances of the solvent for ¹³C (CDCl₃=δ 77.0). Peak multiplicities are annotated as follows: app=apparent, b=broad, s=singlet, d=doublet, t=triplet, q=quartet, p=quintet, m=multiplet.

Gel permeation chromatography (GPC) was carried out in THF on two PolyPore columns connected in series with a 1260 Infinity variable wavelength detector (both from Agilent), a DAWN multi-angle laser light scattering (MALLS) detector, and an Optilab T-rEX differential refractometer (both from Wyatt Technology). dn/dc values were obtained for each injection by assuming 100% mass elution from the columns.

### Synthetic Procedures. NBE Monomer 4

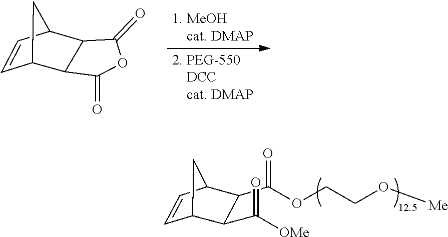

To a flame-dried round bottom under positive N₂ pressure was added, a stir bar, exo-carbic anhydride (1.2 g, 7.29 mmol), DMAP (0.934 g, 7.65 mmol), and dry methanol (20 mL). The reaction mixture was stirred until all the starting material was consumed, determined by analysis of ¹H NMR spectra of reaction mixture aliquots. Methanol was removed under reduced pressure and the compound was redissolved in 60 mL DCM and washed 3 times with 20 mL 1 M HCl. The organic layer was separated and dried by sodium sulfate. The organic layer was then removed under reduced pressure and the product (1.24 g, 87%) was used without further purification.

A solution of the above product (0.98 g, 5 mmol), DCC (1.54 g, 7.5 mmol), and dry DCM (2.5 mL) was added dropwise over 3 hours via a syringe pump to a flame-dried round bottom flask containing a neat mixture of PEG-550 monomethyl ether (5.5 g, 10 mmol) and DMAP (61.1 mg, 0.5 mmol) under positive N₂ pressure. The reaction mixture was stirred for 12 hours and filtered through celite. The filtrate was concentrated under reduced pressure, redissolved in Et₂O, and filtered again through celite. The filtrate was concentrated by removal of Et₂O under reduced pressure. The compound was then redissolved in dry THF, cooled with an ice bath, and SO₃-pyridine (1.2 g, 7.5 mmol) was added under positive N₂ pressure to convert the hydroxyl end group of residual PEG to sulfate to facilitate its removal. The reaction mixture was stirred for 12 hours, and then the solvent was removed under reduced pressure. The compound was redissolved in Et₂O and filtered through celite. The filtrate was concentrated and purified by column chromatography to yield 4 as a viscous, colorless liquid. (2.6 g, 68%). Physical properties: colorless, viscous fluid. ¹H NMR (500 MHz, CDCl₃) δ; 6.21 (s, 2H), 4.25 (m, 1H), 4.15 (m, 1H), 3.68 (t, J=4.8 Hz, 2H), 3.65 (m, 35H), 3.55 (m, 2H), 3.38 (s, 3H), 3.09 (s, 2H), 2.62 (m, 2H), 2.11 (d, J=9.4 Hz, 1H), 1.59 (s, 1H), 1.48 (d, J=9.4 Hz, 1H). ¹³C NMR (125 MHz, CDCl₃) δ 173.76, 173.38, 137.80, 71.76, 70.40, 68.88, 63.66, 58.83, 51.60, 47.00, 45.52, 45.40, 45.23.

### NBE Monomer 6

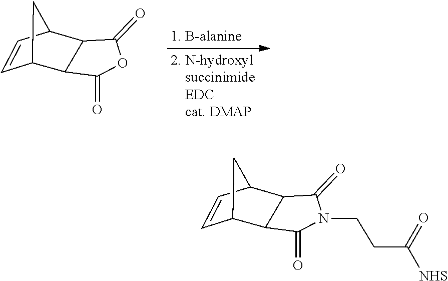

To a round bottom flask with a stir bar was added exo-carbic anhydride (0.42 g, 2.55 mmol), β-alanine (0.227 g, 2.55 mmol), 5 mL glacial acetic acid. The reaction mixture was refluxed for 2 hours. The acetic acid was then removed under reduced pressure and the product was used without further purification.

To a flame-dried round bottom under positive N₂ pressure was added a stir bar, the above product, and EDC-HCl (0.623 g, 3.25 mmol). The reaction mixture was stirred at room temperature for 30 minutes. DMAP (61.1 mg, 0.5 mmol) and NHS (0.316 g, 2.75 mmol) were then added in one portion and the reaction mixture was stirred until all starting material was consumed as determined by TLC. The reaction mixture was concentrated under reduced pressure and purified by column chromatography to yield a white solid (740 mg, 77%). Physical properties: White hydroscopic solid. ¹H NMR (500 MHz, CDCl₃) δ; 6.29 (t, J=1.7 Hz, 2H), 3.89 (t, J=7.2 Hz, 2H), 3.29 (t, J=1.8 Hz, 2H), 3.01 (t, J=6.9 Hz, 1H), 2.81 (s, 4H), 2.74 (s, 2H), 1.51 (d, J=9.7 Hz, 1H), 1.21 (d, J=9.9 Hz, 1H). ¹³C NMR (125 MHz, CDCl₃) 177.52, 168.69, 165.99, 137.80, 47.84, 45.16, 42.89, 33.64, 28.81, 25.51.

Polymer Synthesis. In a nitrogen-charged glove box, NBE monomers 1-6 and DHF were dissolved in THF at 0.15 M for NBE. For P3, 5 equiv, 3-bromopyridine was added to the monomer solution. A stock solution of G3 catalyst in THF (10 mg/mL) was prepared in a separate vial. The desired amount of catalyst was injected into the monomer solution and the reaction was stirred at room temperature until the desired monomer conversion was reached. The polymerization was then quenched with several drops of ethyl vinyl ether and stirred for 10 min. Polymers were precipitated into a poor solvent (cold diethyl ether for copolymers of 4, MeOH for all others), collected by centrifugation (3300 rpm, 10 min), and dried under vacuum.

Preparation of Crosslinked Acrylate-Bearing Copolymers. Terpolymers of monomers 1 (270 or 290 equiv.), 6 (30 or 10 equiv.), and DHF (300 equiv.) were dissolved in DCM with a small amount of AIBN (˜0.5 mg) and transferred to a silanized petri dish. The petri dish was covered and solvent was allowed to evaporate overnight. The dish was then transferred to a vacuum oven and heated to 70° C. under vacuum for 20 h. After cooling, the polymer film was removed from the petri dish and cut with a razor into samples for mechanical testing.

Polymer Degradation. To a 5 mg/mL solution of degradable polymer in 1 mL THF was added one drop of 1 M HCl. The homogeneous solution was swirled and allowed to stand for 30 min. The crude mixture was analyzed by GPC.

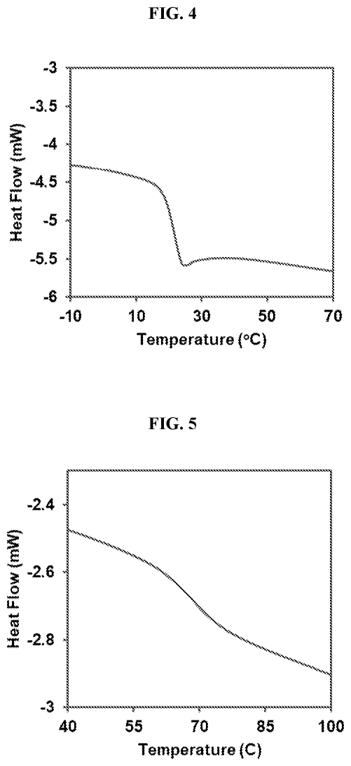

Thermal Characterization. Differential scanning calorimetry measurements of P1, P5, and P6 under N₂ atmosphere with a heating rate of 10° C./min, are presented in FIGS. 4, 5, and 6, respectively.

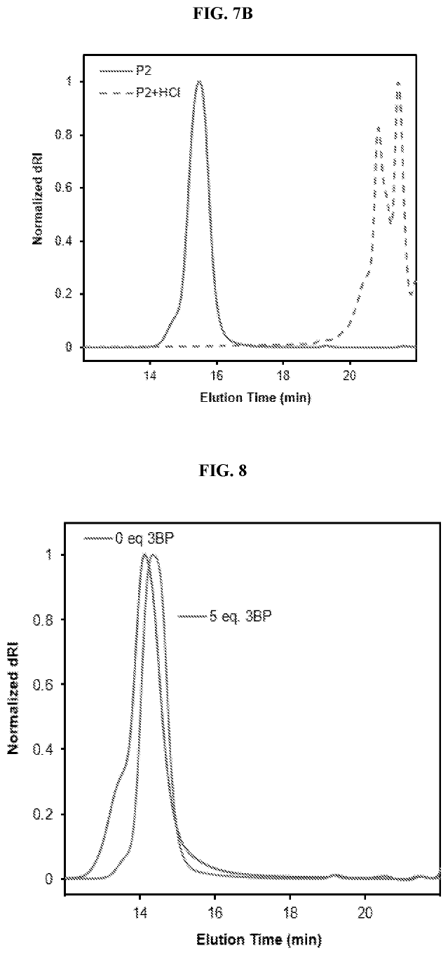

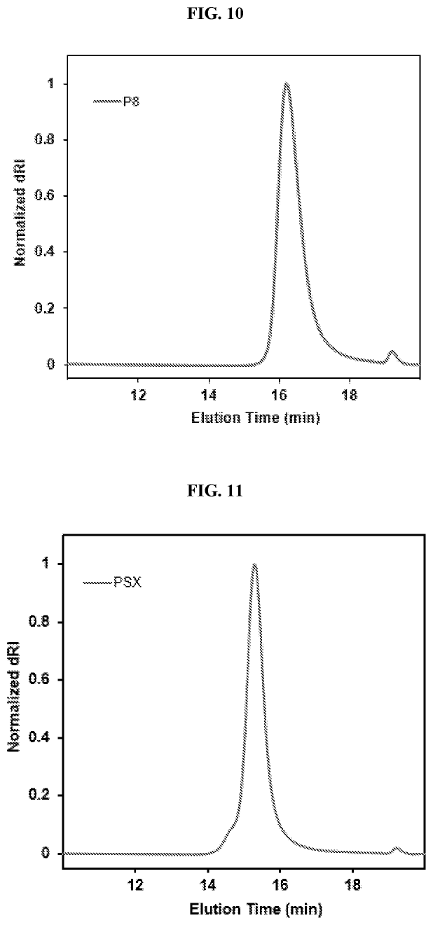

FIGS. 7A and 7B show GPC traces of (a) P1 and (b) P2 with their respective acid-catalyzed degradation products. FIG. 8 shows GPC traces of 1/DHF copolymer at a total target DP=600 synthesized with and without added 3-bromopyridine. FIG. 9 is GPC traces showing the degradation of P7 under aqueous conditions with 5% v/v acetic acid. FIG. 10 is a GPC trace of P8 demonstrating the compatibility of acrylate groups with DHF-NBE co-ROMP, and FIG. 11 shows a GPC trace of PS2 (acrylate terpolymer).

Copolymerization Kinetic Study. A kinetic study of ROMP of NBE 1 and DHF using G3 at [1]₀=[DHF]₀=0.15 M and room temperature. DHF was fixed at 100 equiv (to G3) and 1 was varied at 50 (black), 100 (red), or 200 (purple) equiv (to G3). Dotted lines are the best-fit linear trendlines. The results are presented in FIG. 12.

Reactivity ratio calculation. Reactivity ratios were calculated using the Fineman-Ross method [Journal of Polymer Science 1950, 5 (2), 259-262] using the earliest time point for each kinetic measurement. This method rearranges the Mayo-Lewis equation into linear form:

G=Hr₁−r₂

Where r₁ and r₂ are the reactivity ratios of the two comonomers, G=f₁(2F₁−1)/(1−f₁)F₁ and H=f₁²(1−F₁)/(1−f₁)²F₁. F₁ refers to the mole fraction of monomer 1 in the polymer backbone while f₁ refers to the mole fraction of monomer 1 in the comonomer feed. FIG. 13 is a Fineman-Ross plot for the copolymerization of 1 with DHF with linear fit line, linear fit equation, and fit parameter R².

Functionalized Terpolymers. Terpolymers were polymerized as described in the synthetic procedures above.

TABLE 2
ROMP Copolymers of 2,3-Dihydrofuran with Norbornenes.ₐ

| | | | | | Comonomer | | | | |
|---|---|---|---|---|---|---|---|---|---|
| | | | | Polymerization | Incorporation | Conv. | M_{n, MALLS} | M_{n, theo} | |
| Polymer | NBE | DP | [NBE]₀:[DHF]ₒ:[G3]₀ ^{b} | time (h) | (NBE:DHF) ^{c} | (%)^{d} | (kDa) ^{e} | (kDa) ^{f} | Ð ^{g} |
| PS1 | 1 | 5 | 90:10:100 | 2 | 100:87 | 95 | 24.0 | 26.3 | 1.21 |
| PS2 | 1 | 7 | 90:10:100 | 2 | 100:78 | 95 | 24.7 | 26.2 | 1.18 |
| PS3 | 4 | 6 | 90:10:100 | 2.75 | 100:95 | 93 | 51.6 | 60.5 | 1.15 |
| PS4 | 1 | 6 | 90:10:100 | 2 | 100:76 | 84 | 24.0 | 23.2 | 1.08 |

ₐROMP was performed under an N₂ atmosphere at room temperature in THF with [NBE]₀ = 0.15M.
^{b} Initial equivalents of NBE:DHF:Grubbs initiator.
^{c} Ratio of monomers incorporated into copolymers, determined by ¹H NMR spectroscopy in CDCl₃.
^{d}Conversion of NBE determined by ¹H NMR spectroscopy.
^{e} Determined by GPC MALLS analysis in THF.
^{f} Theoretical Mₙ based on NBE conversion and composition determined by ¹H NMR.
^{g} M_{w}/Mₙ.

Synthesis.

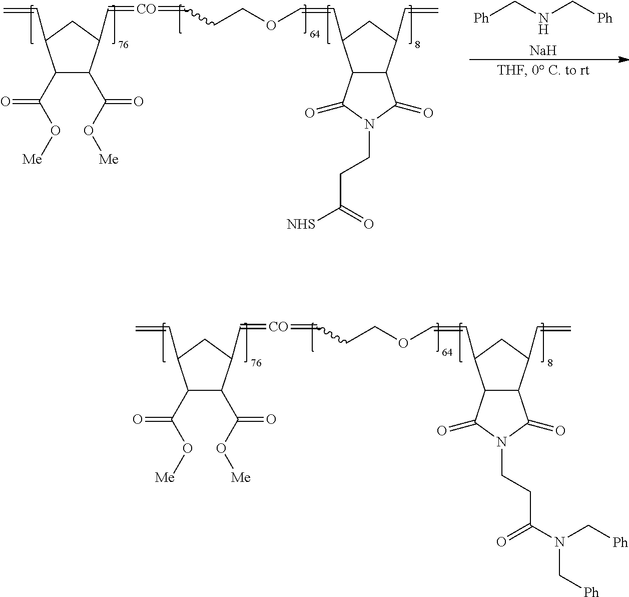

To a flame-dried vial with a stir bar was added NaH (60% dispersion in mineral oil, 20 mg) and anhydrous THF (11.8 mL). The vial was sealed and cooled with an ice bath. Then dibenzylamine (62.3 uL) was added dropwise and the mixture was stirred in the ice bath for 15 minutes. In a second flame-dried vial, PS4 (97 mg) was added and sealed. The vial was cooled with an ice bath and 1 mL of the NaH/dibenzylamine stock solution was added to the polymer. The reaction mixture was stirred in the ice bath for 1 hour and then at room temperature for 7 hours. The functionalized polymer was then precipitated dropwise into cold methanol. The precipitated polymer was collected by centrifugation and washed three times with cold methanol to remove residual dibenzylamine, and washed three times with cold hexanes to remove the oil used to disperse NaH. The polymer was dried under high vacuum overnight and then analyzed by ¹H NMR and GPC. FIG. 14 illustrates GPC traces of PS4 before and after functionalization with benzylamine.

Tensile Testing. Uncrosslinked copolymers were solvent cast from a concentrated DCM solution in a covered Petri dish overnight and dried at 40° C. under vacuum for 24 h. Crosslinked copolymers were prepared as outlined above (Synthetic Procedures). Rectangular samples (3 mm wide) were cut from a uniform film of each tested copolymer with a razor blade. Duplicate samples were synthesized and prepared separately. Tensile testing was performed on a Linkam Mechanical Tester with an extension rate of 4 μm/s using a 200 N load cell.

TABLE 3
Tensile properties of NBE-DHF copolymer samples.

| Polymer | E (MPa) | UTS (MPa) | Strain at Break (%) |
|---|---|---|---|
| P3 | 17 | 2.29 | 536 |
| P3 | 20 | 2.34 | 503 |
| P9 | 780 | 14.3 | 236 |
| P9 | 750 | 12.9 | 280 |
| P10 | 776 | 24.6 | 121 |
| P10 | 810 | 23.2 | 131 |
| P11 | 996 | 34.6 | 28 |
| P11 | 1154 | 33.1 | 24 |

Degradation/Dissolution of Crosslinked Polymer. To a 2 dram vial equipped with a magnetic stir bar was added P10 (20 mg), THF (2 mL), and 1 M HCl (3 drops). The suspension was stirred at room temperature, and the previously insoluble polymer was fully dissolved within 10 min. The solution was dried with MgSO₄, filtered, and analyzed by GPC.

TABLE 4
Solid-state Degradation of NBE-DHF copolymers.^{a}

| | | Shelf | | |
|---|---|---|---|---|
| NBE | [NBE]₀:[DHF]₀:[G3]₀ ^{b} | time (d)^{c} | M_{n, MALLS} (kDa) ^{d} | Ð ^{e} |
| 1 | 100:100:1 | 0 | 32.6 | 1.04 |
| 1 | 100:100:1 | 14 | 25.2 | 1.25 |
| 4 | 100:100:1 | 0 | 66.4 | 1.09 |
| 4 | 100:100:1 | 14 | 60.9 | 1.15 |

^{a}ROMP was performed under an N₂ atmosphere at room temperature in THF with total [NBE]₀ = 0.15M.
^{b}Initial equivalents of NBE:DHF:G3.
^{c}Samples stored in vials under ambient conditions.
^{d}Determined by GPC MALLS analysis in THF.
^{e}M_{w}/Mₙ.

FIG. 15 is a GPC trace of degraded crosslinked polymer P10. Stress-strain curves of P10 immediately following synthesis and after storing for 14 days under ambient conditions are presented in FIG. 16

Example 2: Enol Ethers as Chain-Transfer Agents in Bulk Ring-Opening Metathesis Polymerization (ROMP) of Dicyclopentadiene. The solvent-free synthesis of linear, telechelic polymers and copolymers of dicylopentadiene (DCPD) with controlled molecular weight was explored. Linear polyDCPD is interesting as an engineering material with excellent physical properties while telechelic polyDCPD and DCPD copolymers have applications as chemically-resistant thermoset materials (e.g. as coatings or resins for additive manufacturing).

By simply adding linear enol ethers (including inexpensive, commercial examples such as butyl vinyl ether and ethyl 1-propenyl ether) to the neat ring-opening metathesis polymerization (ROMP) reaction of DCPD using Grubbs catalyst at moderate temperature (40° C.), polymers with controlled average molecular weights and end-groups are synthesized. The properties of these polymers can be tuned by altering the polymer molecular weight (via control over ratio of monomer to vinyl ether) and composition (via use of comonomers including norbornenes or 2,3-dihydrofuran).

Linear, nondegradable dicyclopentadiene. PolyDCPD is a commercial plastic material that is prepared by ROMP and is currently experiencing an increase in market growth rate. It is used for the production of agricultural equipment, automotive body panels, piping, engineering material reinforcement, downhole tools, subsea insulation, circuit boards, pressure vessels, and parts for the energy generating industry, among others. Typically-prepared polyDCPD is limited by its high crosslink density which limits its processability, recyclability, and mechanical properties. Despite the extremely high impact toughness of polyDCPD, studies have shown that lowering the number of crosslinks in polyDCPD further enhances its material properties. It has been claimed that one of the main challenges surrounding the polyDCPD market is gaining control over crosslinking. We have found that polymerization of DCPD in the presence of linear enol ethers prevents the formation of crosslinks, providing a strategy to easily generate linear polyDCPD. Furthermore, control over the polymer end groups provides access to both complex polymer architectures and simple, controlled crosslinking strategies. Any company that sells polyDCPD may be interested in this invention for use in producing high-performance materials. The Army has also issued a call for proposals for funding of companies to produce linear polyDCPD for use in armor.

Modern production of polyDCPD is limited by the high density of produced crosslinks in the material. This prevents the use of polyDCPD in solvent-based processing (eg for composite production) and diminishes the material's fracture toughness and high-velocity impact behavior. However, linear polyDCPD is expected to have excellent high-velocity impact performance and toughness, potential for solution-based processing, and the potential for post-processing functionalization.

Resins for additive manufacturing. PolyDCPD has been largely excluded from consideration as a viable additive manufacturing material due to its rapid metathesis polymerization and uncontrolled crosslinking. However, its excellent mechanical properties make it attractive as a high-performance 3-D printed material. Synthesis of linear, telechelic polyDCPD will enable the controlled curing of polyDCPD-based resins in additive manufacturing. Generation of linear polyDCPD makes the material processable while controlled end groups provide a synthetic handle for controlled crosslinking. For example, installation of acrylate chain ends enables radical curing under photochemical and mild thermal conditions. Furthermore, copolymerization with 2,3-dihydrofuran enables degradation of the printed materials. Companies engaged in high-performance 3D printed materials will be interested in this technology.

A major limitation of additive manufacturing is the mechanical properties of common resins. By comparison, polyDCPD has excellent mechanical properties. The low cost of DCPD also keeps these resins economically viable. The ability to install almost most functionalities in these resins makes them compatible with a range of 3D printing chemistries.

Chemical-resistant polymeric coatings cured at mild temperatures. A wide market exists for chemical resistant coatings in industrial settings. PolyDCPD is known to be highly chemically resistant in addition to its excellent mechanical properties. However, its rapid metathesis polymerization and uncontrolled crosslinking make its application as a coating impractical if not impossible. The use of telechelic and/or functional linear polyDCPD as resin rather than DCPD monomer itself circumvents these issues. Furthermore, acrylate-telechelic polyDCPD can be readily cured below 100° C., a critical benchmark enabling this material to coat plastic parts that cannot withstand exposure to high temperatures. Other curing chemistries (e.g. epoxy) are also available to this system. This application would be of interest to companies that produce coatings for parts in industrial systems.

There exists a significant need for chemical-resistant coatings that can be applied and cured at moderate temperature (<100° C.). Linear, telechelic polyDCPD can fulfill this curing condition while maintaining excellent chemical resistance.

### Example 3: Copolymerization of Cyclic Enol Ethers with any Cyclic Alkenes

### Synthesis Using 1,5-cycloctadiene

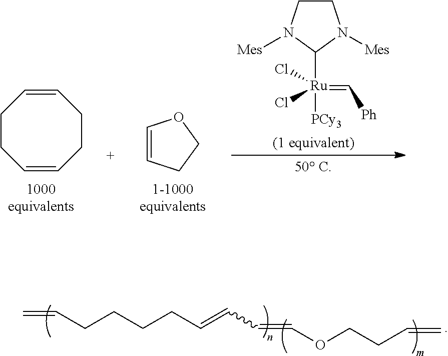

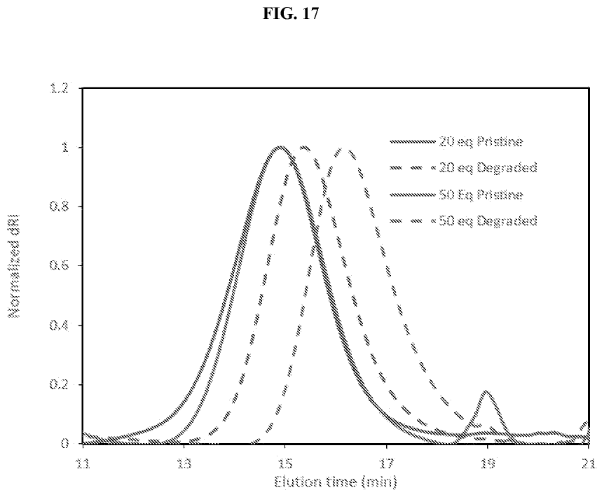

Exemplified above is the copolymerization of 1,5-cyclooctadiene, using 20 and 50 equivalents of 2,3-dihydrofuran. The product was prepared and degraded using dilute HCl in tetrahydrofuran. The products were analyzed by GPC (FIG. 17).

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising.” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1-41. (canceled)

42. A method of forming a polymer, the method comprising:
contacting one or more cycloalkenyl monomers with a ring-opening metathesis catalyst in the presence of an enol ether to provide a polymerizable solution; and
initiating polymerization of the one or more cycloalkenyl monomers with the enol ether to provide a copolymer, wherein:
the enol ether is a substituted or unsubstituted 2,3-dihydrofuran, a substituted or unsubstituted 2,3-dihydropyran, a mixture thereof, or a linear enol ether, and
a rate of the polymerization of the one or more cycloalkenyl monomers with the enol ether is decreased relative to a rate of polymerization of the one or more cycloalkenyl monomers without the enol ether in the same conditions.

43. The method of claim 42, wherein the ring-opening metathesis catalyst comprises at least one ruthenium(II) carbene complex.

44. The method of claim 42, wherein the ring-opening metathesis catalyst is of the formula: 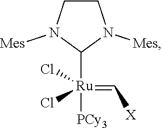
wherein:
X is OR′, NR′₂, SR′, or SeR′; R′ is substituted or unsubstituted alkyl, substituted or unsubstituted cycloalkyl, substituted or unsubstituted aryl, or substituted or unsubstituted heteroaryl; Mes is mesitylene; and Cy is cyclohexyl.

45. The method of claim 44, wherein the ring-opening metathesis catalyst is dichloro(benzylidene)bis(tricyclohexylphosphine)mthenium(II) (Grubbs I), dichlorofl, 3-bis(2, 4, 6-trimethylphenyl)-2-imidazolidinylidene](benzylidenextricyclohexylphosphine) ruthenium(II) (Grubbs II), Dichloro[1,3-bis(2,4,6-trimethylphenyl)-2-imidazolidinylidene](2-isopropoxyphenylmethylene)ruthenium(II) (Hoveyda-Grubbs II), or dichloro{1, 3-bis(2, 4,6-trimethylphenyl)-2-imidazolidinylidenej(benzyliden-e)bis(3-bromopyridine)ruthenium(II) (Grubbs III).

46. The method of claim 42, wherein the one or more cycloalkenyl monomer comprises a substituted or unsubstituted norbornene.

47. The method of claim 46, wherein the one or more cycloalkenyl monomer comprises dicyclopentadiene

48. The method of claim 42, wherein the enol ether is a linear enol ether and the presence of the linear enol ether suppressed crosslinking of the polymer.

49. The method of claim 42, wherein the polymer is suitable for solvent-based processing.

50. The method of claim 42, wherein the one or more cycloalkenyl monomer is of the formula: 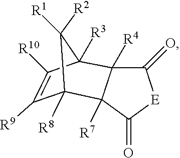
wherein:
E is O, NR¹¹ or CR¹²₂; and
R¹¹ and R¹² are individually H, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, substituted or unsubstituted aryl, or substituted or unsubstituted heteroaryl.

51. The method of claim 42, wherein the one or more cycloalkenyl monomer comprises 1,5-cyclooctadiene.

52. The method of claim 42, wherein the rate of the polymerization of the one or more cycloalkenyl monomers with the enol ether is decreased by at least a factor of 5, relative to the rate of polymerization of the one or more cycloalkenyl monomers without the enol ether in the same conditions.

53. The method of claim 42, wherein the polymerization is initiated by heating the polymerizable solution to a temperature above 25° C.

54. The method of claim 53, wherein heating the polymerizable solution occurs concurrently with contacting the one or more cycloalkenyl monomers with the ring opening metathesis in the presence of the enol ether.

55. The method of claim 42, further comprising, curing the polymer to form a chemical-resistant coating.

56. The method of claim 42, wherein the polymerizable solution further comprises reinforcing fibers.

57. The method of claim 56, wherein the polymer is a fiber-reinforced polymer.

58. The method of claim 42, wherein the polymerizable solution further comprises a nanoscopic filler.

59. The method of claim 58, wherein the polymer is a polymer nanocomposite.

60. The method of claim 42, wherein the at least one enol ether is of the formula: 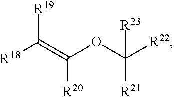
wherein R¹⁸, R¹⁹, R²⁰, R²¹, R²², and R²³ are each independently H, substituted or unsubstituted C₁₋₆-alkyl.

61. The method of claim 60, wherein the polymer is of the formula: 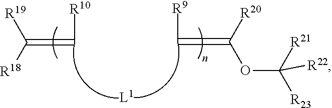
wherein:
L¹ is a substituted or unsubstituted alkyl, substituted or unsubstituted alkyenyl, substituted or unsubstituted cycloalkyl, or substituted or unsubstituted cycloalkenyl group;
R⁹ and R¹⁰ are each individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, substituted or unsubstituted aryl, or substituted or unsubstituted heteroaryl;
R¹⁸, R¹⁹, R²⁰, R²¹, R²², and R²³ are each independently H, substituted or unsubstituted C₁₋₆-alkyl; and
n is 2 to 1,000,000.

62. The method of claim 61, wherein the polymer is of the formula: 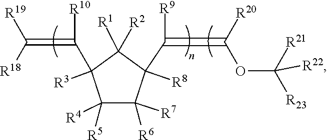
wherein:
R¹, R², R³, R⁴, R⁵, R⁶, R⁷, R⁸, R⁹, and R¹⁰ are each individually H, halogen, substituted or unsubstituted alkyl, substituted or unsubstituted haloalkyl, substituted or unsubstituted ether, substituted or unsubstituted ketone, substituted or unsubstituted ester, substituted or unsubstituted amide, substituted or unsubstituted cycloalkyl, substituted or unsubstituted cycloalkenyl, substituted or unsubstituted heterocycloalkyl, substituted or unsubstituted aryl, or substituted or unsubstituted heteroaryl, or any two or more of R¹, R², R³, R⁴, R⁵, R⁶, R⁷, R⁸, R⁹, and R¹⁰ may join together to form a ring, with the proviso that R⁹ and R¹⁰ are not joined to each other;
R¹⁸, R¹⁹, R²⁰, R²¹, R²², and R²³ are each independently H, substituted or unsubstituted C₁₋₆-alkyl; and
n is 2 to 1,000,000.

63. The method of claim 61, wherein the polymer is of the formula: 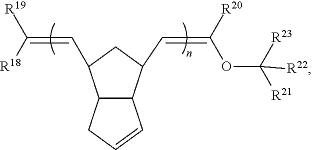
wherein:
R¹⁸, R¹⁹, R²⁰, R²¹, R²², and R²³ are each independently H, substituted or unsubstituted C₁₋₆-alkyl; and
n is 2 to 1,000,000.

64. A method of forming a polymer via frontal ring-opening metathesis polymerization, the method comprising:
(a) contacting a ring-opening metathesis catalyst with one or more cycloalkenyl monomer in the presence of an enol ether, and optionally in the presence of a solvent to provide a mixture;
(b) contacting the mixture with a stimulus in one or more location for a period of time; and
(c) initiating frontal ring-opening metathesis polymerization from the one or more location of the stimulus contact, wherein
the enol ether is a substituted or unsubstituted 2,3-dihydrofuran, a substituted or unsubstituted 2,3-dihydropyran, a mixture thereof, or a linear enol ether, and
the enol ether inhibits initiation of the frontal ring-opening metathesis polymerization at room temperature.

65-66. (canceled)
